(19) United States
(12) Patent Application Publication
(10) Pub. No.: US 2015/0120602 A1
(43) Pub. Date: Apr. 30, 2015

(54) SYSTEM AND METHOD FOR OBJECT DELIVERY AND PICKUP

(71) Applicant: Demand Solutions Consulting Pty Ltd, Hawthorn East, Victoria (AU)

(72) Inventors: Curt James Huffman, Hawthorn East (AU); Asimina Huffman, Hawthorn East (AU)

(21) Appl. No.: 14/401,719

(22) PCT Filed: May 17, 2013
(86) PCT No.: PCT/AU2013/000521

§ 371 Date: Nov. 17, 2014

(30) Foreign Application Priority Data
May 18, 2012 (AU) 2012902055

(51) Int. Cl. G06Q 10/08; G07F 17/12

(52) U.S. Cl. CPC G06Q 10/0836; G07F 17/12
USPC 705/339; 700/214

(57) ABSTRACT

A system and method for delivery of one or more objects is provided. The system and method includes the steps of determining if the object can be delivered to a first location; and in the event that the object cannot be delivered to the first location, a unique identifier is generated. The unique identifier is associated with the object and a reservation request is initiated to deliver the object to a second location. Determination of the second location is based on one or more parameters and notification of successful reservation request and second location is provided. A modular storage system having an actuator is also provided.

### TECHNICAL FIELD

The present invention generally relates to a system, method, computer readable medium of instructions and/or computer program product for object delivery and pickup by a recipient.

### BACKGROUND ART

The postal system, couriers and delivery people can deliver objects which may include mail items to home addresses, but in situations where the object is important, is something which cannot be posted, or is too large to fit into a mail box the object is generally not left in the mail box or in the mail room, but rather a notification or “left card” is provided with details for the recipient to pick the object up from a central location, such as a Post Office or collection point in the case of a courier. The Post Office or collection point may be nearby but may not be. Further, the pick-up may point may generally have limited opening hours. Another problem with courier services is that they may try to deliver a parcel several times (up to 2 or 3 attempts) if the recipient is not at home. This may dramatically increase the cost of delivery to the couriers and ultimately, the consumer. Further, some couriers may leave parcels on a porch or unsecure place which leaves the object vulnerable to theft.

It would therefore be desirable to provide a system, method and/or computer readable medium of instructions which may alleviate or at least ameliorate one or more of the above problems.

Reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which the specification relates.

### DISCLOSURE OF INVENTION

According to a first aspect, the present invention provides a computer implemented method for delivery of one or more objects including the steps of: determining if the object can be delivered to a first location; and in the event that the object cannot be delivered to the first location: generating a unique identifier, associating the unique identifier with the object; initiating a reservation request to deliver the object to a second location; determining a second location based on one or more parameters; and providing notification of successful reservation request and second location.

Advantageously, the present invention may no longer require couriers to write out a notification card with a mail or tracking number for the recipient. The present invention may provide predetermined unique identifiers to couriers which contain a unique identifier, such as a barcode or a QR code or a two dimensional barcode or any other suitable code.

A further advantage is that the method of the invention may be used as a shared service by any number of couriers or deliverers. Presently, some couriers are able to provide a storage service for members who request it (i.e. a PO Box which may be statically or dynamically allocated), but these storage services rarely are available to other competing couriers. Even if available, commercial arrangements for pricing and billing their competitors are very challenging. The present invention allows multiple customers to use the services and second locations (storage units). Service of multiple customers through a common set of second locations will provide greater market efficiencies and lower costs.

Further efficiencies can be realised from providing storage to other types of objects beyond only couriered parcels. Items such as pharmaceuticals and refrigerated storage of fresh foods may increase overall efficiencies.

Preferably, the method may further include the steps of determining an optimal second location and or an optimal compartment within the second location based on one or more parameters.

The parameters may include one or more of the size of the object, the type of object, courier preferences, recipient preferences or size and availability of a compartment, temperature and humidity requirements of the object and/or the preferences of the operator of the storage system or its partners.

Preferably, determining an optimal second location may be based on one or more parameters. The parameters may include one or more of: the second location being within a threshold distance from a recipient address, a type of object to be delivered, the environmental requirements of the object, one or more predetermined delivery preferences; based on other objects to be delivered at the same time; or number of objects in a multi-object consignment.

Preferably, the optimal second location is determined based on the availability of multiple compartments at the second location. For example, the system and method of the present invention may scan the network of available parcel storage compartments (and not necessarily limited to a single unit or compartment) to determine which storage compartments provides an optimal fit for the request, and for example, the level of service agreed with the courier company.

The method may further include the step of extracting predetermined object data for each object. The predetermined object data may include the size, dimensions, shape, weight, fragility or type the object, and/or environmental requirements.

Preferably, initiating a reservation request for a second location may include scanning the object's unique identifier via a mobile communication device.

According to a second aspect, the present invention provides, a computer implemented method for storage of one or more objects including the steps of: generating a unique identifier, associating the unique identifier with the object; scanning the unique identifier associated with the object at a second location, the second location including one or more compartments for storage of objects, and the second location including one or more reservations associated with the one or more compartments; matching the unique identifier with the reservation; unlocking an appropriate reserved compartment in the second location for the one or more objects; closing the compartment after a predetermined time or detection of object inside the compartment; locking the compartment once the compartment is in a closed state; providing inventory data relating to compartment; and notifying the recipient that the object has been stored in the second location.

Preferably, the compartment may be locked upon closure or once a predetermined time period has expired since the compartment was closed. Preferably, inventory data may include a time stamp each time the compartment is opened and closed.

According to a third aspect, the present invention provides a modular storage system, including: a housing having a base panel, two opposing side panels and a rear panel between the two opposing side panels; one or more removable modular compartments provided within the housing; each compartment including: two opposing side compartment panels, a base panel, a rear panel and a front panel; the front panel including a locking component, wherein the one or more compartments further include an actuator for locking and unlocking the front panel and an actuator for opening and closing the front panel of each of the one or more compartments; and a control system for controlling the actuators.

Advantageously, the present invention allows objects to be delivered directly to a second location and further allow the objects to be stored within a compartment.

Preferably, a ceiling panel extends between the side panels and the rear panel.

Advantageously the storage system of the present invention may be transportable and extendable. In a further advantage, the modularity of the compartments together with their ease of replacement may allow the storage system to be reconfigured at will.

Preferably, the one or more removable modular compartments may include an anchoring component for attachment to the housing. The anchoring component may be formed on an outer face of one of the compartment panels.

Preferably, the one or more of the compartments may include a common maximum depth Z, and one or more compartments may have a width and height that are a fraction of the interior dimensions of the housing such that for a combination of compartments within the storage unit, the sum of the widths of the compartments and the sum of the heights of the compartments may be equal to width and height of the interior dimensions of the housing within specified tolerances. For example, the compartments may be preferably further sized such that a gap is provided between compartments to allow for ease of removal (when appropriate).

In an alternative embodiment, the one or more compartments may have a common depth Z, one or more compartments may have width X and height Y, and one or more of the compartments may include a width and height that is a fraction of the width X and height Y such that, for a combination of compartments within the storage unit, the sum of the widths of the compartments and the sum of the heights of the compartments may be equal to width and height of the interior dimensions of the housing.

In a further alternative embodiment, the one or more compartments may have a common depth Z, one or more compartments may have width X and height Y, one or more compartments may have width ½ X and height ½ Y, one or more compartments may have width ½ X and height Y and one or more compartments may have width X and height ½ Y,

Preferably, the housing may include a frame to position each of the one or more compartments in the housing within tolerances.

In a further alternative, any of the compartments may be subdivided with independently opening and locking doors.

Preferably, the one or more compartments may share one or more of a common a wall panel, side panel, base panel or ceiling panel between adjacent compartments.

Preferably, the housing may include an environmental control system adapted to control the temperature of the one or more compartments.

Advantageously, the temperature control system controls temperature and humidity of individual compartments which allows for storage of temperature dependent or temperature-sensitive objects.

### BRIEF DESCRIPTION OF THE DRAWINGS

The invention will now be described in further detail with reference to the accompanying drawings. It is to be understood that the particularity of the drawings does not supersede the generality of the preceding description of the invention.

FIG. 1 is a schematic diagram showing a system and method for object delivery;

FIG. 2a is a schematic diagram showing a system and method for storing one or more objects;

FIG. 2b is a schematic diagram showing the unique identifiers that may be used with the system and method shown in FIGS. 1 and 2a;

FIG. 3 is a flow diagram illustrating an example method of the invention according to an embodiment;

FIG. 4 is a flow diagram illustrating an example method of the invention according to an embodiment;

FIG. 5a is a flow diagram illustrating an example method of the invention according to an alternative embodiment;

FIG. 5b is a flow diagram continuing from FIG. 5a illustrating an example method of the invention according to an alternative embodiment;

FIG. 6a is a flow diagram illustrating an example method of the invention according to an alternative embodiment;

FIG. 6b is a flow diagram continuing from FIG. 6a illustrating an example method of the invention according to an alternative embodiment.

FIG. 7a is a diagram of a storage unit according to the invention;

FIG. 7b is a diagram of an alternative storage unit according to the invention;

FIG. 8 is a diagram showing the operation of the control system included in the storage unit of FIG. 7a;

FIG. 9 is a diagram illustrating the compartments which can be arranged within the storage unit of FIG. 7a;

FIG. 10a-10h illustrates various examples of compartments which may be included in the storage unit of FIG. 7a,

FIG. 11 is a schematic diagram illustrating the operation of the environment control system according to an embodiment of the invention;

FIG. 12 is a schematic diagram illustrating the operation of the compartment control system according to an embodiment of the invention; and

FIG. 13 is a diagram showing the network aspect of the invention according to an alternative embodiment.

### DETAILED DESCRIPTION

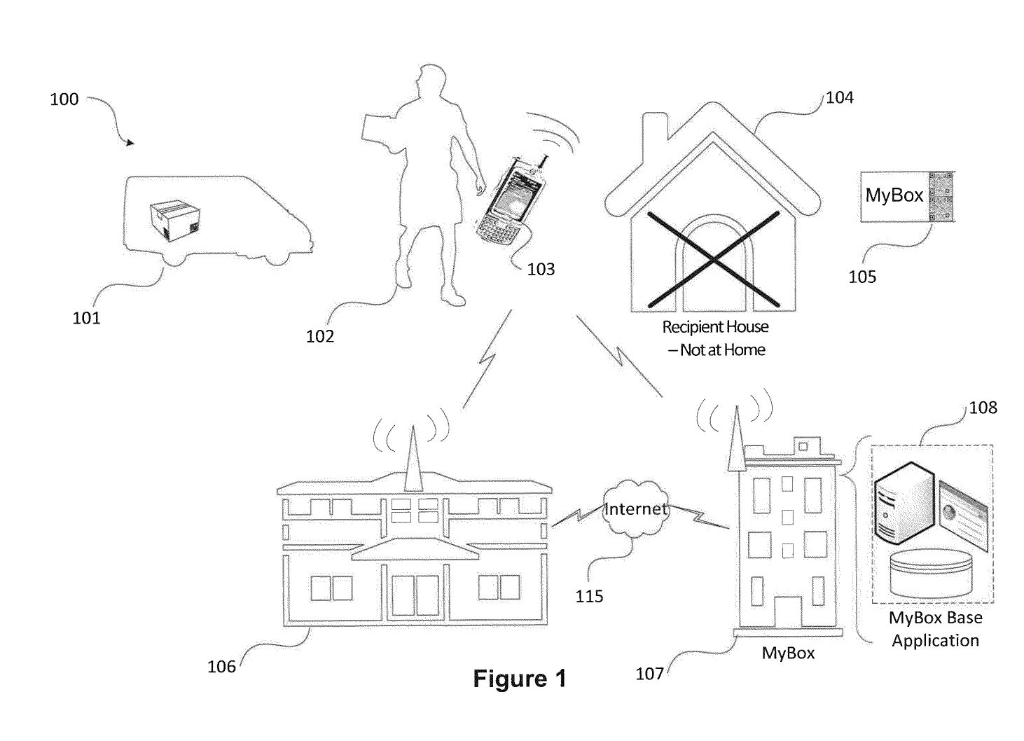

Referring to FIG. 1, there is shown an example system 100 for object delivery by a courier and later pickup by a recipient. The invention will be described in relation to how a courier or delivery person may use the system when no recipient is present to accept an object. It is to be understood that an object may include a mail item, parcel, registered mail, groceries, pharmaceuticals and the like including in some cases, goods requiring special environmental requirements such as refrigeration, etc.

Typically, couriers may leave a notification or left card at an address to indicate that a delivery attempt was made. Advantageously, the present invention may no longer require a courier to write out a card with a mail or tracking number for the recipient. The present invention may provide predetermined unique identifiers to couriers which may contain a unique identifier, such as a barcode or a QR code or a two dimensional barcode or suitable code.

The system 100 includes a MyBox component 107 which includes a MyBox base application 108. MyBox component 107 and MyBox Base Application 108 are connected to a courier company component 106 via a communication network, such as the Internet 115 or another type of communications network, such as privat network, virtual private network (VPN), switched telephone, cellular telephone and data, mesh network or the like.

MyBox component 107 is connected to one or more courier companies 106 and/or location partners (who may provide storage for objects) to configure and operate the network of MyBox storage units 110. The MyBox base application 108 supports the processes of the MyBox component 107 and automates certain processes. In particular, the MyBox base application 108 includes a computer program and database, with an Internet portal component and/or a private network connection integrated into the application. The computer program includes a number of optimisation algorithms which provide a variety of ways to select the optimal compartment and location to store an object for a given reservation. The MyBox component 107 configures the use of these optimisation algorithms—alone, staged, or in combination—based on the desired commercial objectives. Advantageously, the system and method of the present invention may scan the network of available parcel storage compartments (not necessarily limited to a single unit or compartment) to determine which storage compartments provides an optimal fit for the request and for the level of service agreed with the courier company.

The courier company component 106 is connected to one or more mobile communication devices 103 which are associated with a courier 102 who may be driving a courier transport vehicle 101, for example. The mobile communication device 103 used by the courier 102 may also be in direct communication with the MyBox component 107. Also, included are one or more recipients 104 to which one or more pre-printed MyBox left cards 105 may be provided in the event the recipient is not home. In operation, when a failed delivery attempt is made by the courier 102, the courier 102 uses a pre-printed MyBox left card 105. The MyBox left card 105 includes a unique identifier, such as a barcode or a QR code or a two dimensional barcode or any other suitable code along with an authentication hash.

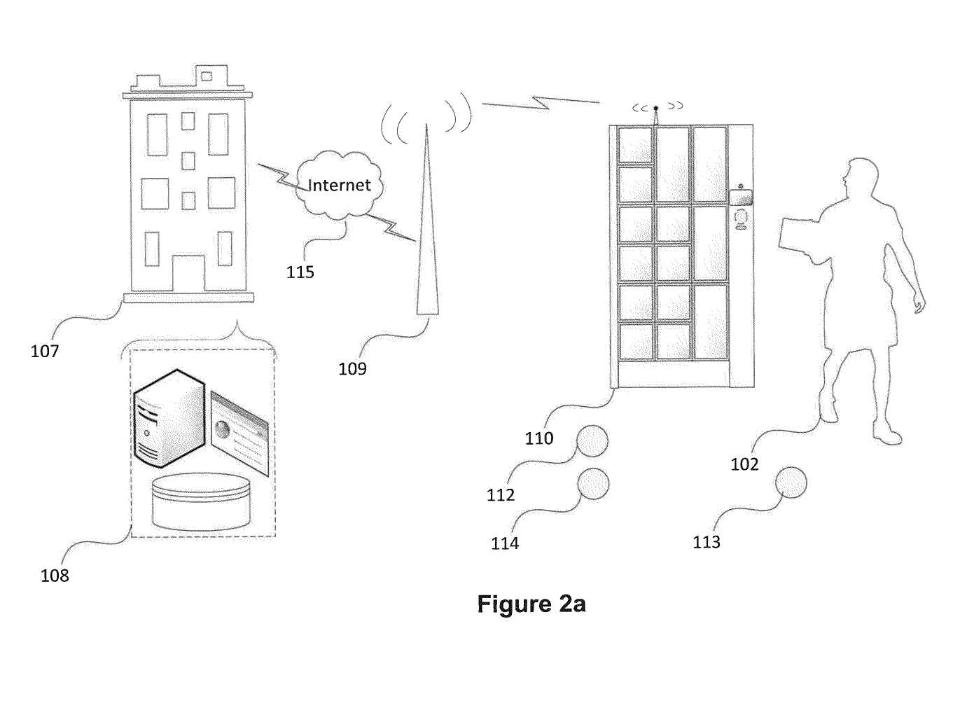

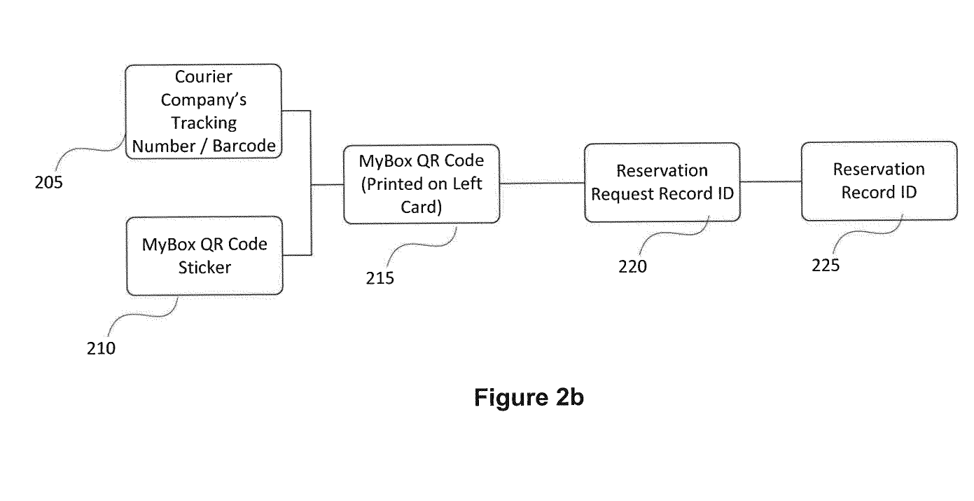

The courier 102 scans unique identifier on the card 105 and any package tracking barcode associated with the package to be delivered. The unique identifier is then associated with the object and will be further described with reference to FIG. 2b. The unique identifier may be associated with the object by applying the unique identifier to the object. Where the courier company 106 does not use tracking barcodes on their parcels, MyBox will provide preprinted left cards 105 which will contain a unique identifier printed on the card 105 and an identical unique identifier on a removable sticker that the courier 102 can apply to the parcel. Advantageously, using pre-printed Left Cards with unique identifiers in this manner easily enables the recipient to retrieve their object at a later time. Alternatively, delivery instructions related to the parcel's tracking code barcode may be provided. By scanning the unique identifier using their mobile communication device 103, the courier 102 sends a reservation request to the MyBox component 107 either directly or via the courier company component 106.

The MyBox left card 105 may be a physical paper printed on cardstock or may be electronic, but contains the details and unique identifier and authentication code enabling a courier 102 to make a MyBox reservation request for a particular object, as well as instructions for the recipient to retrieve their object. The system and method of the present invention may pre-print these cards and issue them to participating courier companies 106 and couriers 102 or they may be printed dynamically if the courier 102 has a printer associated with their mobile communication device 103. These cards 105 may supplement or replace their usual left cards previously left for recipients by couriers 102 to notify the recipients of undelivered objects returned to the depot.

The MyBox component 107 will process the reservation request and locate and reserve a suitable second location for the object and advise the courier 102 of the second location. In operation, courier transport 101 provides the courier 102 with means for transporting one or more objects to and from storage units together with actually attempting to deliver the object to the recipient. The courier 102 will attempt to deliver the objects to the address indicated and in the event that the recipient 104 is not at home may initiate a reservation request via their mobile communication device 103. The mobile communication device 103 may take any form including a mobile computer, a personal digital assistant, smart phone and the like. The mobile communication 103 device may be used to scan object tracking codes associated with either the postal service or the courier services together with unique identifiers associated with the MyBox component 107 to initiate reservation requests of a second location in which to store the object. It is envisaged that most couriers 102 use a handheld mobile computer (or PDA—Personal Digital Assistant) 103 which provides a variety of functions. These mobile communication devices 103 may also have unique identifiers used in transactional messages. This allows scanning of barcodes and wireless communication back to the courier company component 106 in order to provide proof of delivery and proof of pick up (via cellular networks such as GSM, GPRS, CDMA, HSDPA, etc.) These mobile communication devices 103 can also receive information sent from the courier company component 106 to the courier 102. The mobile communication devices 103 will scan barcodes (1D and 2D) for object tracking. They may also combine GPS, and Bluetooth, as well as cameras, and signature capture. GPS may be used to record the precise location where a courier delivers an object. GPS may also be used to assist the courier 102 with navigation of the route or to particular addresses. The method and system of the present invention may interact with mobile communication devices 103 either directly or indirectly, depending on the needs of the participating courier company 106. The method and system of the present invention expects that couriers 102 will initiate reservation request transactions by scanning the unique identifiers which may be the courier company's tracking code on the object or the QR codes on the MyBox left cards 105. These transactions may be sent to the courier's back office systems associated with company component 106 which will provide (and may augment) the data necessary for the reservation request and send it on to MyBox's base application 108.

Similarly, MyBox component 107 expects to send reservation details to the courier via these devices. This could be sent directly to the courier's mobile communication device 103, or via the courier company's systems 106.

The MyBox component 107 provides reservation and storage location information back to the courier 102 via their mobile communication device 103. Typically, this transmission may occur via radio transmission (GPRS, HSDPA, EDGE and the like). Depending on the courier company, information flow may pass through the courier company component 106 as an intermediary between the MyBox component 107 and the courier 102—or it may happen directly. The MyBox left card 105 may be provided to the courier company 106 and the courier 102 directly. The courier 102 may use these cards 105 in place of a standard “left card”. MyBox will provide couriers with pre-printed cards 105 which are to be left in secure locations in the event of a failed delivery attempt for the intended recipient. It will be appreciated that an electronic notification may be provided to the recipient instead of (or in addition to) the card 105. Electronic notification is possible where the courier company 106 has the recipient's mobile telephone number or email address from the sender/shipper. Alternatively, if they are registered with MyBox component 107, then a lookup can be performed on the MyBox base application 108 and contact information may be obtained from a system record potentially enabling electronic notification to the recipient.

The MyBox left card 105 may include two matching unique identifiers which may be in the form of Quick Reference (QR) codes. One of these QR images may be printed on the MyBox left card 105 itself, and the other identical QR image may be printed on a removable sticker affixed to the card for application to the object. In addition, the card 105 may include instructions for the recipient to contact MyBox to determine the location of their object and how to access it.

In the scenario where the recipient receives the pre-printed Left Card 105, the recipient need only scan the unique identifier, such as barcode or QR code on the Left Card 105 at the scanner port on the storage unit. As this unique, single-use code is uniquely associated with the reservation and the locked compartment within the storage unit, the storage unit will open the compartment for access. The user does not need to receive or enter a PIN or other code. If the unique identifier were somehow damaged and unreadable by the scanner, then the user may also manually enter the code at the storage unit. In the scenario where a virtual left-card is sent via email or SMS, these may also contain a unique identifier, such as a barcode or QR code image. The recipient may print this out for scanning, or simply hold their receiving device, such as a tablet PC or smartphone, to be scanned by the storage unit. Further, an application could enable the use of NFC on a smartphone to be used to verify the recipient and grant them access.

Advantageously, these features not only provide a uniquely convenient aspect to the recipient, but provide greater flexibility and security. Recipients do not need to remember a PIN or passcode to gain access, although a PIN or passcode may still be used. In addition, the recipient need not remember in which compartment their item(s) are stored. The storage unit will always open the correct compartment(s) for them to receive their item(s). The fact that the unique identifiers are single-use tokens with billions of possible combinations greatly enhance the security aspect of authentic access.

In another advantage, the the recipient does not need to pre-register or sign up with the system before they can participate. Partner couriers will be able to access the services of the system for any recipient. There is no need for any prior communication between courier and recipient, nor any sort of ‘clearinghouse’ of delivery or redirection messages, nor any sort of tricky timing required for these messages to be effective.

If, after an item is stored, the recipient may elects not to retrieve their item and they may simply call the courier to re-deliver it. In this case the courier will merely register that particular reservation to be collected by the courier on the next routed delivery, and pick up the item. The recipient may also initiate this process directly from MyBox component 107. The recipient can also opt-out of any future storages by notifying MyBox component 107 of this preference. In this case any courier requesting to store a parcel for the named person and/or address will be informed that the request is rejected and will follow their standard protocol. (i.e. status quo for redelivery.)

Advantageously, the invention may also utilise the camera(s) on and in the storage unit to capture and store an image of the person accessing the unit. This further enhances security as well as provides an additional service element that is very important to the courier and shipper—Proof of Delivery (POD). This image may be uploaded to the MyBox base application 108, and may be provided upon request for POD by the courier or shipper—as is allowed by privacy regulations and terms and conditions of the services. Alternately, where fraud, misuse, or vandalism is experienced, these images can be shared with the proper authorities.

Couriers may identify and authenticate themselves at the storage unit via standard issue badges, RFID cards, or NFC cards issued by their courier company. These can be issued and maintained by their courier company or by MyBox. These can be enhanced by requiring a further PIN of passcode known only to the courier. This will eliminate the need for couriers to memorise codes or to carry keys for storage units. Further, it will eliminate inferior implementations where all the couriers know the passcodes for all the storage units. MyBox storage units will have the ability to restrict access to any given unit to only those couriers routed for it. This enhances the security aspect of the invention by further reducing the ‘rogue courier’ risk.

Courier company component 106 may be involved in the reservation request process by receiving a MyBox component 107 reservation request from the courier 102 (via their mobile communication device 103) and may obtain data about the object and delivery and then forward that data to MyBox component 107 to make the reservation. Alternatively, the courier 102 via their mobile communication device 103 may interact directly with the MyBox component 107. Communication between the MyBox base application 108 and the couriers 103 or courier companies 106 advantageously enables reservations to be made throughout the entire network of parcel storage lockers.

Similarly, the MyBox component 107 may send messages back to the courier company component 106 or directly to the courier 102 via their mobile communication device 103.

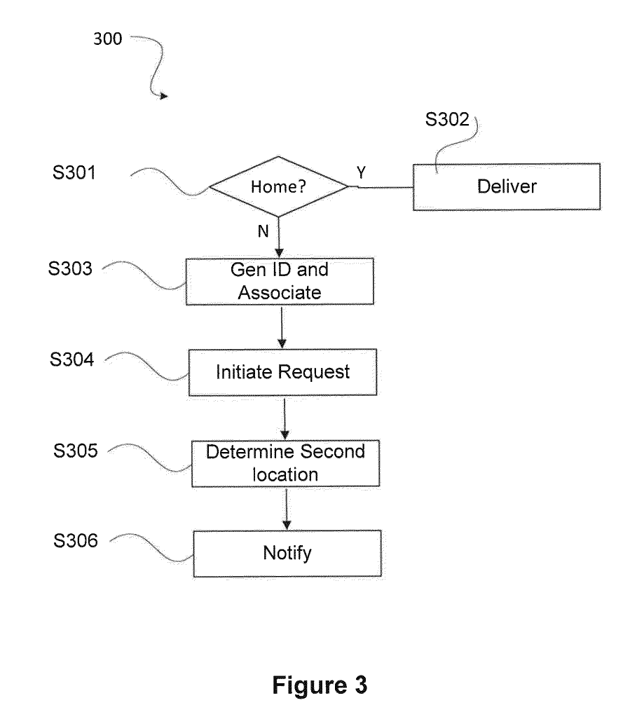

The MyBox component 107 receives and validates reservation requests from couriers 102. The MyBox component 107 will also validate the unique identifier of the MyBox left card 105 and the QR code will also hold an authentication hash. It also determines the optimal storage unit and compartment within the second location (as will be further described with reference to FIG. 3). The MyBox component 107 creates a reservation for the object and notifies the courier 102 via their mobile communication device 103 of the reservation and the location of the second location. The information is preferably just the physical location of the second location, but the MyBox component also sends the reservation details to the second location together with a compartment ID. The compartment ID may also optionally be provided to the courier 102 via their mobile communication device 103. As will be appreciated this may happen by direct communication to the courier 102 or via the courier company component 106.

Preferably the communication between the MyBox component 107 and the couriers 102 via their mobile communication device 103 will be directly via secure and encrypted messaging over the Internet.

The MyBox base application 108 supports the MyBox component 107 processors through software functionality. It maintains a real time inventory of storage units and each compartment together with future reservations and past reservations. It also tracks unique identifiers associated with reservations and objects. The MyBox base application 108 will process a reservation request and return an optimized reservation for the courier 102 (or a rejection if no suitable compartments are available). The MyBox base application 108 may search for an appropriate second location for the request based on a number of criteria, such as object dimensions, object weight, recipient preferences (if known), delivery address, compartment availability and location.

The MyBox base application 108 preferably includes one or more optimisation algorithms employed to select the optimum second location and the optimum compartment based on a variety of parameters. The optimum compartment may, from the point of view of the courier company be one that maximises space utilization (i.e. placing a small object in an appropriately sized small compartment for example).

Alternatively, or where possible in combination with the above, the optimal storage unit 110 from the point of recipient may be a location that is most convenient for them either by distance from their home or by preferred pickup location. For example, where the recipient is unknown to the system 100, the default optimum optimal storage unit 110 may be a location that is nearest to their delivery address. In this case, a simple distance algorithm between delivery address and available compartment locations may be used.

In the event the recipient is a registered member of the system 100, their stated preferences can be used to determine the optimal storage unit 110. For example, most convenient could mean one that is next to their work location, and they have selected one or more optimal storage units 110 in their preferences profile and in order of preference.

It will be appreciated that in certain circumstances the recipient preferences may not be used at all and the preferences of the courier company may be used instead (for example, a lower cost offering from the courier company—where the recipient does not have the choice or preference of second location). In this case, the optimal storage unit 110 may be the most efficient, or what provides the fewest number of stopping points for a courier 102 along a route. A point-to-line distance or ‘route-closest’ calculation may be carried out which measures the distance of each available compartment to the courier's route (or the portion of the route remaining).

Advantageously, the system 100 may also determine if the courier 102 has any existing reservations for objects that he/she has not yet stored. If so, the courier 102 may be prompted to store this (second) object at the same storage unit 110 where the courier 102 has another reservation.

Probabilities may be applied to determine the likelihood that further objects the courier 102 may be carrying will require reservations. A forecast may then be provided indicating general locations (or specific objects) along the route where the courier will likely require reservations. Cluster analysis may then be used to determine the overall fewest storage unit 110 stops needed to store the anticipated objects, and use this in combination with ‘route closest’ algorithm to determine the most efficient storage unit 110. Advantageously, this may result in fewer storage unit 110 stops—even if the suggested storage unit 110 is not the closest one to their route.

The system may also determine ‘hot’ and ‘cold’ spots in its network of optimal storage units 110. That is, areas of high demand for storage, and areas of low demand for storage. The system 100 may balance this out by shifting some reservations to ‘colder’ second locations where possible. A ‘weighting’ may be applied to one or more determined colder second locations. The weighting may be used in combination with other algorithms described above thereby improving utilisation across the network of storage units 110.

The weighting may also include charging higher fees at ‘hotter’ storage units 110 than ‘colder’ ones. For example, using a cost per unit of time, the algorithms that use time-efficiency above can be converted to economic efficiency so that they can be compared and can find the most ‘economical’ compartment to satisfy their reservation request. Preferably, to make efficient use of the overall storage capacity available, the algorithms will rank smaller storage compartments as more desirable than larger ones, while excluding compartments that are too small to accommodate the object.

The system 100 may select from the one or more algorithms to apply by generating a composite score for each compartment that is a candidate for each reservation request. The MyBox base application 108 will select the highest score for that particular reservation. The system 100 may elect to simply offer the courier 102 their choice of algorithms, or it may select for a given courier company their most efficient algorithms.

It will be appreciated that a variety of algorithms may be employed to select and reserve the ‘optimal’ storage compartment for the item. The optimisation may be based on the agreements and rates paid by partner couriers, or may be adapted based on competition in the market, or may be optimised to provide best utilisation of the storage network

The system 100 may consider the context of each reservation request to determine which scoring method to apply. A scoring method may be a combination of various algorithms and a weighting factor for each to generate a composite score.

The system 100 may consider the context of each reservation request to determine the scoring method and weighting for compartments. Contexts may include for example: (a) courier company and commercial agreements (e.g. fees, overall volume of storage, ratio of left card reservations to membership reservations, partnering tier of courier company, etc.); (b) overall demand in a particular geography at that time; (c) location provider agreements; (d) demand for particular storage unit 110; and (e) recipient status and tier.

It will be appreciated that all of the ‘optimisation’ may take place dynamically and the system 100 may respond to a courier's reservation request in a timely manner.

A threshold distance may be applied to the selection of algorithm since in scoring all available compartments, it is likely that there may be an available compartment which is not within a practical distance to the recipient or courier 102. The optimisation may also include a threshold distance that will take into consideration how far the recipient or courier 102 travels to a second location from their residence (or addressed location) to avoid inconvenience.

The threshold distance may be determined by the courier 102 or by the courier company 106, by the member's preferences, or by the system 100. Storage units 110 and their respective available compartments outside of the threshold distance will not be considered for reservation selection. In the event there are no available compartments within the threshold, the reservation request will be rejected.

It will be appreciated that the selection of the storage unit 110 and compartment may be further based on predetermined object data including but not limited to the fragility or other characteristic of the object such as controlled items (pharmaceuticals), dangerous items (explosives, firearms etc.) high value items or environmental requirements (such as temperature, anti-static compartments. etc.).

Provided that a second location is available, control moves to step 306 in which the second location is communicated. Typically this communication is provided from the MyBox base application 108 via mobile communication device 103 to the courier 102. The MyBox base application 108 also communicates this reservation to the MyBox storage unit 110.

FIG. 2a is a system diagram illustrating storage of the object at a second location once a reservation request has been made by the courier 102. The MyBox component 107 and MyBox base application 108 are connected via a communication network, such as the Internet 115 to a cellular communications tower 109 which is in turn connected to a MyBox storage unit 110. It will be appreciated that there will be more than one MyBox storage units located in one or more geographic locations.

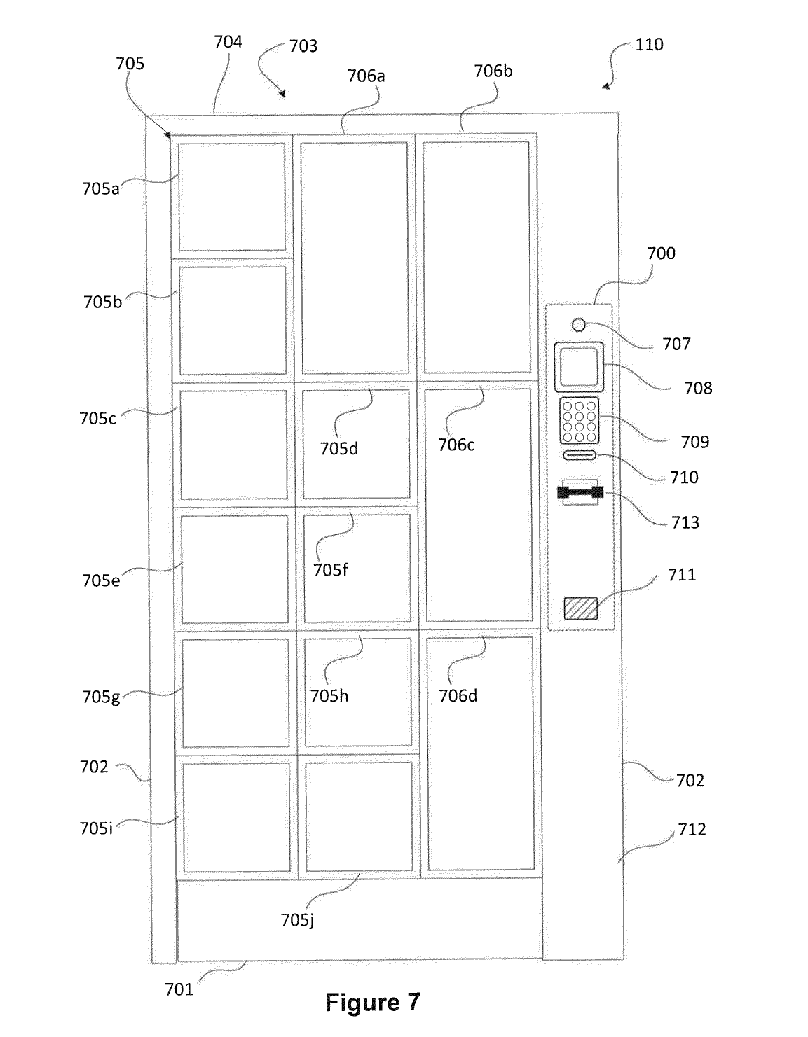

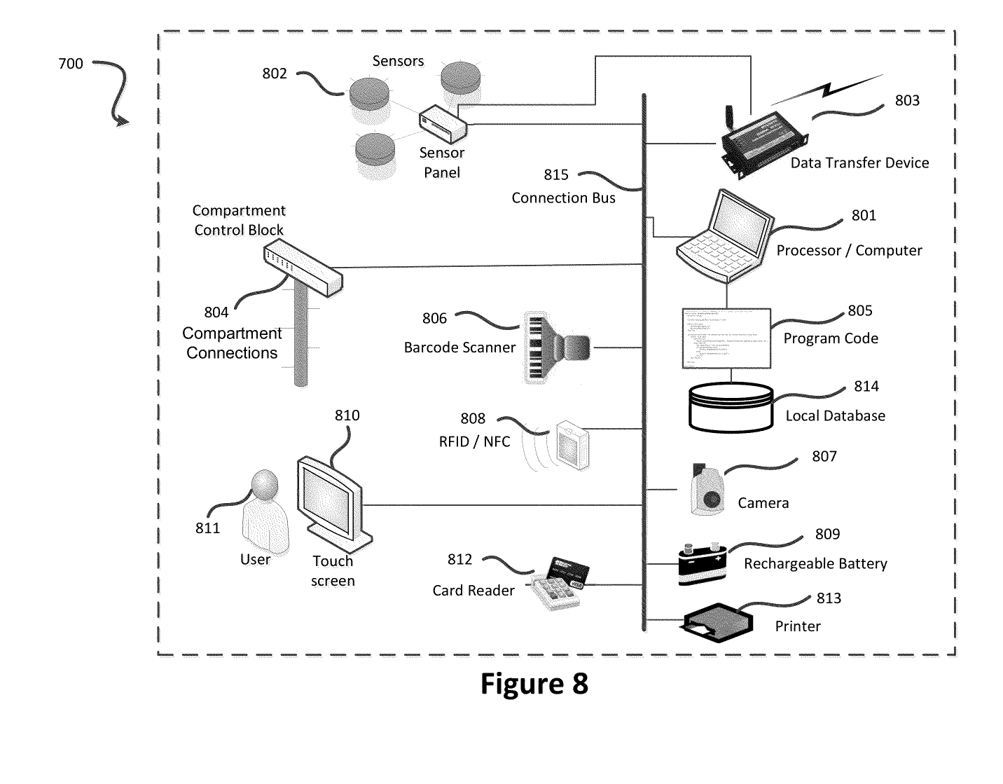

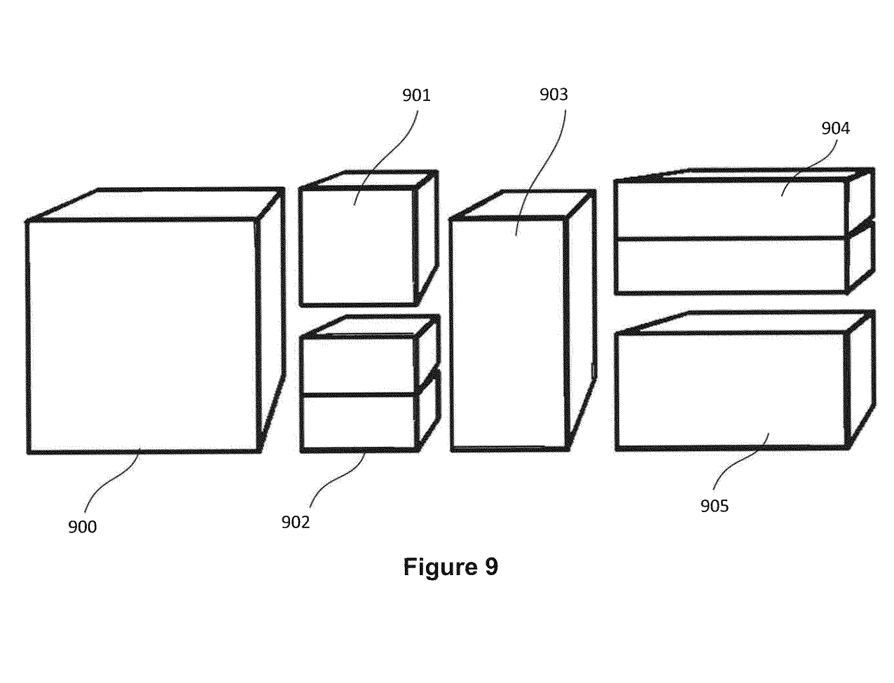

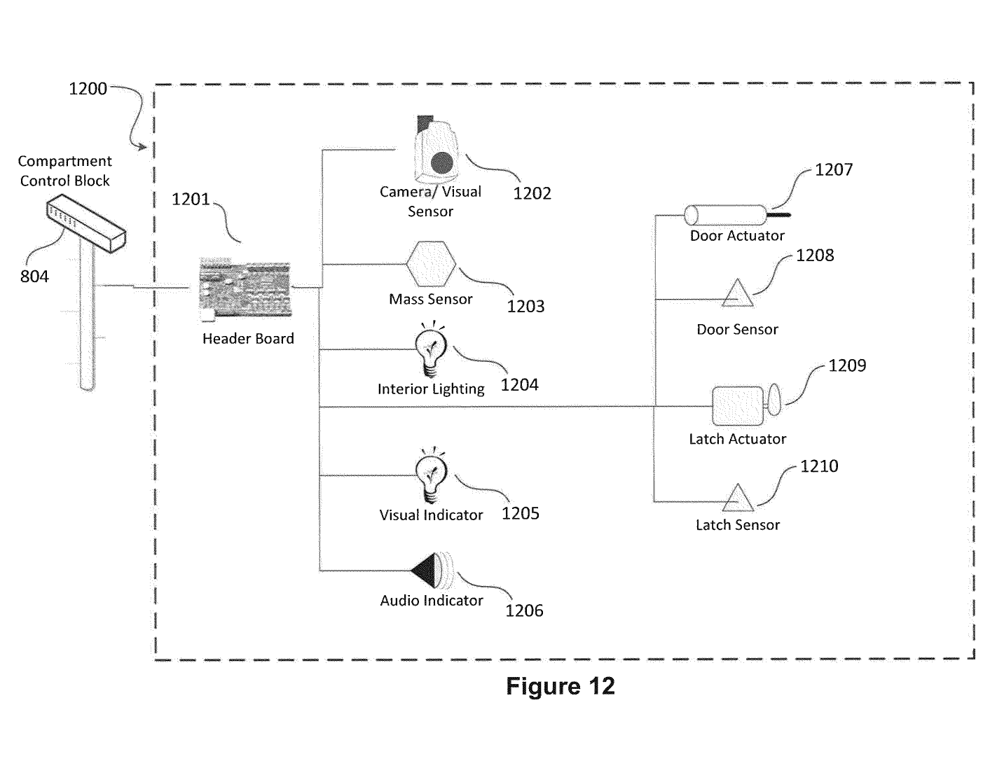

Depending on the volume of objects to be delivered in a geographic location, the storage unit 110 may take the form of a secure cabinet or room, which may be the size of a vending machine up to a building containing one or more rooms for example. Each of the buildings, rooms or cabinets may contain multiple storage compartments (which will be described further with reference to FIGS. 7a and 7b) for objects. The storage unit 110 may be controlled by an embedded computer system running a custom software application to execute processes and to control the opening/closing, locking and unlocking of each compartment through a compartment control system. The control of the operation of the storage unit is further described with reference to FIG. 8. The storage unit 110 may also include an environmental control system as will be further described with reference to FIG. 12.

It will be appreciated that the compartment is used to generally refer to the storage compartment(s) within storage unit 110 as will be described further with reference to FIGS. 7a and 7b. The compartments may vary in size or shape.

The MyBox storage unit 110 receives reservations from the MyBox component 107 (via mobile Internet communication made up of components 109 and 115) and maintains its own inventory of compartments within the storage unit and their status (for example available or not available). It maintains regular communication with the MyBox base application 108 to ensure consistent processing and consistent data. In the event that the communications link to the MyBox base application 108 is disrupted, the unit 110 and its control system may operate and process independently using its last known set of data.

In operation, the courier 102 will arrive at the storage unit 110 as per the instructions from the MyBox base application 108 confirmation message (which has appeared on their mobile communication device 103). The courier 102 will scan the unique identifier on the object via a scanner (shown in FIG. 8) on the MyBox storage unit 110. The MyBox storage unit 110 will confirm the unique identifier and the reservation for one or more of its compartments. It will then unlatch the reserved compartment store and open the door, or if not a matching code, it will process this as an exception and may display an error. The courier 102 can then place the object into the compartment opened by the unit and will close the door of the compartment for each object to be delivered. The courier 102 will repeat this process for each object with a reservation at the particular storage unit 110. The courier 102 then will proceed to another MyBox storage unit 110 at another location to drop off other objects with reservations. The MyBox storage unit 110 can detect if and when the courier 102 has closed the compartment door or may automatically close the compartment door after a predetermined time period and lock the compartment. The MyBox storage unit 110 also updates the inventory data within the unit and communicates all events to the MyBox base application 108. This information then may be relayed to the courier company 106 and/or to the recipient. The MyBox base application 108 maintains a master inventory of all compartments and all reservations for all MyBox storage units 110. In the event that the recipient is a person known to MyBox 107 and the MyBox base application 108 has their details, then the MyBox base application 108 will send the recipient a notification message depending on user preferences to notify them of the storage of the object.

FIG. 2b is a schematic diagram illustrating the unique identifiers which may be used in FIGS. 1 and 2a. The unique identifier may take the form of a tracking code 205 provided by the courier company (such as a barcode or tracking number) or may take the form of a QR code 210 on a sticker which is applied to the object. In the case of tracking code 205, it may be associated with a QR code 215 which is printed on a MyBox left card 105 and left at the delivery address. The QR code 215 is associated with the courier code 205 through scanning for example and sending both identifiers in a reservation request (such as that described with reference to FIG. 1). In the event that a QR code 210 was used, the QR code 210 and 215 may be identical. The QR code described above is an example, and it will be appreciated that the unique identifier may take any suitable form—such as a visual coded identifier, an electromagnetic identifier, such as an RFID tag or NFC token, or another technology. A reservation request record identifier 220 may be provided which may be a database identifier for the reservation request transaction record held in the MyBox base application 108. Finally, the reservation record identifier 225 is a further database identifier for the reservation record held in the MyBox base application 108.

The reservation request may include one or more of the following fields:

| Field | Description | Type/Example |
|---|---|---|
| Recipient Name | Recipient Name | String; E.g. “Mr. Martin |
| | | Smith” |
| Member ID | Member ID | Unique ID string; e.g.: |
| | | MyBox X9X9X9 |
| Ship To Street | Street Address | String; E.g. “123 Main |
| Address | | Street” |
| Ship To Suburb | City/Suburb | String; E.g. “Hawthorn” |
| Ship To State | State | String; E.g. “VIC” |
| Ship To Post | Post Code | String; E.g. “3122” |
| Code | | |
| Ship To Country | Country | (Australia Only) |
| DPID | Delivery point identifier | (Australia Only) |
| Shipper | An ID string from the | ID String |
| Reference Code | shipper - their | |
| | reference | |
| Shipper Name | Name of the shipper | String |
| Shipper Street | Return Street Address | String; e.g. “123 Main |
| Address | | Street” |
| Shipper Suburb | Return City/Suburb | String |
| Shipper State | Return State | String |
| Shipper ID | MyBox's ID code or the | Float number |
| | courier's ID code for | |
| | the shipper | |
| Weight | Weight of object (kg) | Float number |
| Length | Longest dimension of | Float number |
| | object (mm) | |
| Height | Second longest | Float number |
| | dimension of object | |
| | (mm) | |
| Width | Third longest dimen- | Float number |
| | sion of object (mm) | |
| Shape | Shape of object | E.g. Tube, box, irregular, |
| | | etc. |
| Courier | MyBox unique ID of the | Unique ID String |
| Company ID | Courier (company | |
| | customer ID) | |
| Courier ID | Identification number of | Unique ID String |
| | the Courier (person) | |
| Courier Mobile | Mobile telephone | Phone number |
| | number of the courier | |
| Handheld ID | ID of the handheld | Unique ID String |
| | scanner/communication | |
| | device used by the | |
| | courier; Used for return | |
| | communications | |
| Route ID | Route ID of the object | Unique ID String |
| | or courier is executing | |
| | when reservation is | |
| | made | |
| Courier | Class of shipment for | String |
| Shipment Class | courier | |
| MyBox Mode | MyBox service mode | E.g. Membership mode, or |
| | under which the | Left Card Mode |
| | request is being made | |
| MyBox Class | Used when a customer/ | String |
| | courier has multiple | |
| | classes of MyBox | |
| | service offered to them | |
| Request GPS | Location from where | Formatted String |
| coordinates or | the request is made | |
| geocode | | |
| Ship-To GPS | Location to where the | Formatted String |
| coordinates or | delivery is intended | |
| geocode | | |
| Request Date | Date & time the request | Time/Date |
| Time Stamp | is issued | |
| Courier object | Tracking ID of the | Unique ID String |
| Tracking ID | courier | |
| Consignment ID | Consignment number | String |
| | in which this object | |
| | belongs | |
| Target Delivery | Date & time of the | Time/Date |
| Date/Time | intended storage | |
| Courier's | A unique ID issued by | Unique ID String |
| Request ID | the courier for use in | |
| | tracking & matching | |
| | responses | |
| Temperature | Minimum, maximum or | Float number |
| requirements | preferred temperature | (temperature) |
| | of object (degrees | |
| | Celsius) | |
| Humidity | Minimum, maximum or | Float number (% humidity) |
| requirements | preferred humidity of | |
| | object | |

FIG. 3 is a flow diagram illustrating the method and system of the present invention for providing a notification or left card. The method 300 starts at step 301 where it is determined by a courier 102 whether or not the recipient of an object is home. In the event that the recipient is home control moves to step 302 where delivery of the object is effected.

Otherwise if the recipient is not at home control moves to step 303 where a unique identifier is associated with the object. This may take the form of providing the unique ID in a card 105 which is left with the recipient or in the recipient's mail box or similar secure location or may take the form of an email or SMS message sent to the recipient. As noted in FIG. 2b, there may be two unique identifiers: courier company tracking code or barcode and or the QR code associated with the present invention, but both may be associated within the MyBox base application 108.

Control then moves to step 304 where a reservation request to deliver the object to a second location is carried out. Typically this request is initiated by a courier 102 via their mobile communication device 103 communicating with the MyBox component 107 and in turn MyBox base application 108. Control then moves to step 305 where an optimal second location is determined based on one or more parameters by the MyBox base application 108 and the MyBox storage unit 110. The one or more parameters may include, for example the current location of the courier relative to the nearest available second location.

An optimal second location of the storage unit 110 and compartment is determined for each reservation request. It will be appreciated that any suitable optimisation algorithm may be employed to determine an optimal storage unit 110 and compartment for a given reservation request. Preferably, the optimal storage unit 110 and compartment is the most efficient location based on one or more parameters. The choice of optimisation algorithm may be selected and applied to any given reservation request based on commercial context. The MyBox base application 108 will perform the reservation optimisation based on the programming and configuration determined by the MyBox component 107.

When a reservation request is received from a courier 102, the MyBox base application 108 will select an available storage compartment within a storage unit 110 in which the courier 102 can store the object for the recipient to pick up. Each compartment will be contained within a storage unit 110 and will share its location as will further be described with reference to FIG. 8.

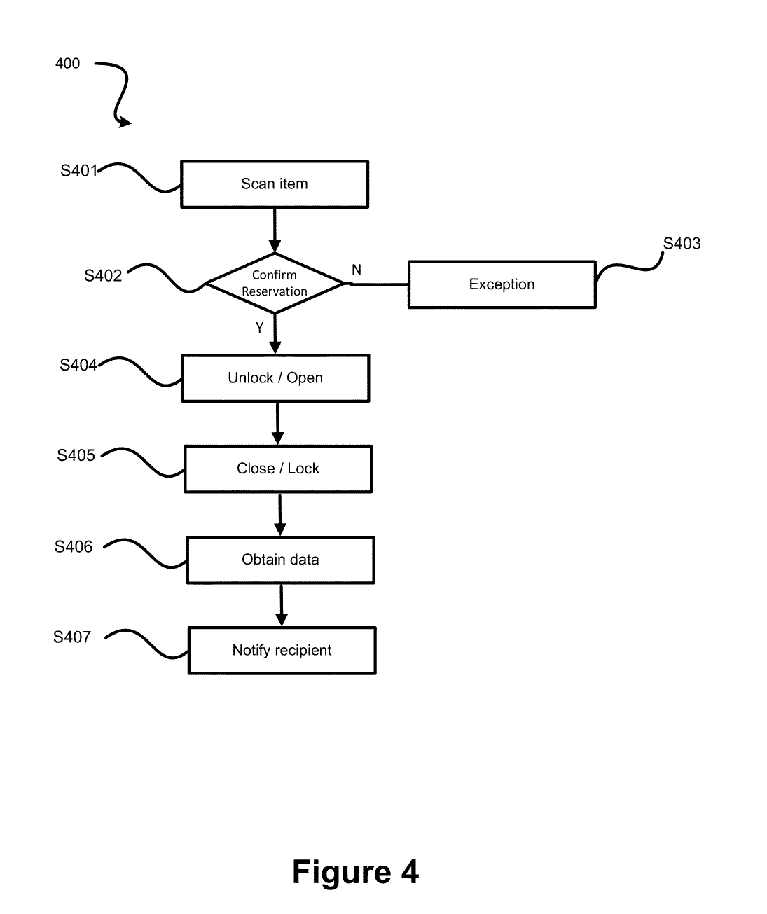

FIG. 4 is a flow diagram illustrating the method 400 for storage of an object at a second location following the allocation of the compartment in FIG. 3. At step 401, one or more objects are scanned via the unique identifier at a second location at which the object is to be stored. Control moves to step 402 where it is determined whether or not the reservation exists by checking the unique identifier and the records in a local database. Communication may be made with the MyBox base application 108 if the storage unit 110 doesn't have that reservation in its local database. In the event that there is no reservation, control moves to step 403 where an exception is handled. The program code 805 associated with the storage unit 110 will determine if an appropriately-sized compartment is available within the storage unit 110 and allow storage and modify the reservation with the MyBox base application 108. If none is available within that storage unit 110, it will advise the courier that that parcel has a reserved compartment at another storage unit 110.

Selection of an appropriately-sized compartment where size of the object is not known may be carried out by a reverse cubing algorithm in which the courier (or courier company) has provided a parcel's weight but not its dimensions. The algorithm will take that particular courier company's 106 cubing factor (AKA dimensioning factor) and apply it to the weight to determine a volume. It will then use a common set of ratios to estimate the parcels maximum dimensions. By multiplying the courier companies' dimensioning factor times the weight of the object, and taking the cube root of the product, the system 100 can calculate the dimension of the object assuming it is a cube. Because of this assumption of the shape, this can only be considered to be an estimate.

Advantageously, by using other common parcel ratios of height, width and length, the system 100 can adjust the formula in order to estimate the various dimensions for common object shapes (e.g. parcels such as a shoe box, a book, a Lego toy, etc.). The system 100 can then take the maximum dimensions of each shape calculation and use these to estimate the size of the object, and therefore the size of the compartment required to store it. These ratios may be continuously updated or ‘learned’ by the MyBox base application 108 using reservation data.

Control moves to step 404 where an appropriate compartment in the second location for the one or more objects is unlocked and opened. Control then moves to step 405 where the door is closed manually or automatically after a predetermined time period has lapsed since the door was unlocked, and then the door is locked. Control then moves to step 406 where inventory data relating to the compartment is relayed to the MyBox base application 108 and in turn to the courier company component 106 via the Internet 115. Control then moves to step 407 where the intended recipient of the object is contacted (if contact details are available) to advise them that their object has been stored in the second location and is ready for collection. Confirmation of object storage may be made by visual or mass detection components such as a camera as will be described with reference to FIG. 12. Visual confirmation of an object in a compartment may be provided by ‘motion detection’ through the analysis of the frames of a digital video feed to determine how much the pixels change from one frame to another. Two still images of the interior of a storage compartment may be compared to determine if the compartment holds an object or is empty. This method is very advantageous over mass-measurement techniques which may or may not detect very light objects.

In a further step, the MyBox base application 108 may be updated when the object is collected by the object recipient.

In the event a recipient does not pick up the stored object after a predetermined time period, one or more reminders may be sent and/or additional storage charges may be charged to the courier or recipient. In an alternative, the courier may pick up and store the object at their depot for recipient pickup, or MyBox may take possession after a legally allowed process/period of time. It will be appreciated that a combination of the above may be used.

Advantageously, the system 100 can also be used for unattended shipment drop off. A shipper can use an interface (such as a website) to the MyBox Base Application 108 to lodge a shipment request for an object, get a quote, make a payment, and receive a QR code for the shipper to print out which corresponds to a drop-off reservation. At an appropriate storage unit 110, the shipper scans the issued QR code, and the storage unit 110 will open a reserved compartment. The storage unit 110 will then close and latch the compartment once the object has been placed inside. MyBox component 107 then requests a pick up by a courier 102 of a courier company 106 with which MyBox component 107 has a shipping agency commercial agreement. The courier 102 logs into the storage unit 110 using an RFID or NFC card, login ID and password, or by scanning a barcode on a pickup docket issued by MyBox 107 for the reservation, or similar method. This identification of the pickup courier 102 will trigger the storage unit 110 to open the appropriate compartment to retrieve the object for shipping. The courier 102 and associated courier company 106 will then process the object per their business as usual. Advantageously, this arrangement reduces cost to the courier company 106 for accepting the shipment and allows the MyBox component 107 to arbitrate shipping services from various courier companies 106 to advantageously provide the best or least cost service to the shipper.

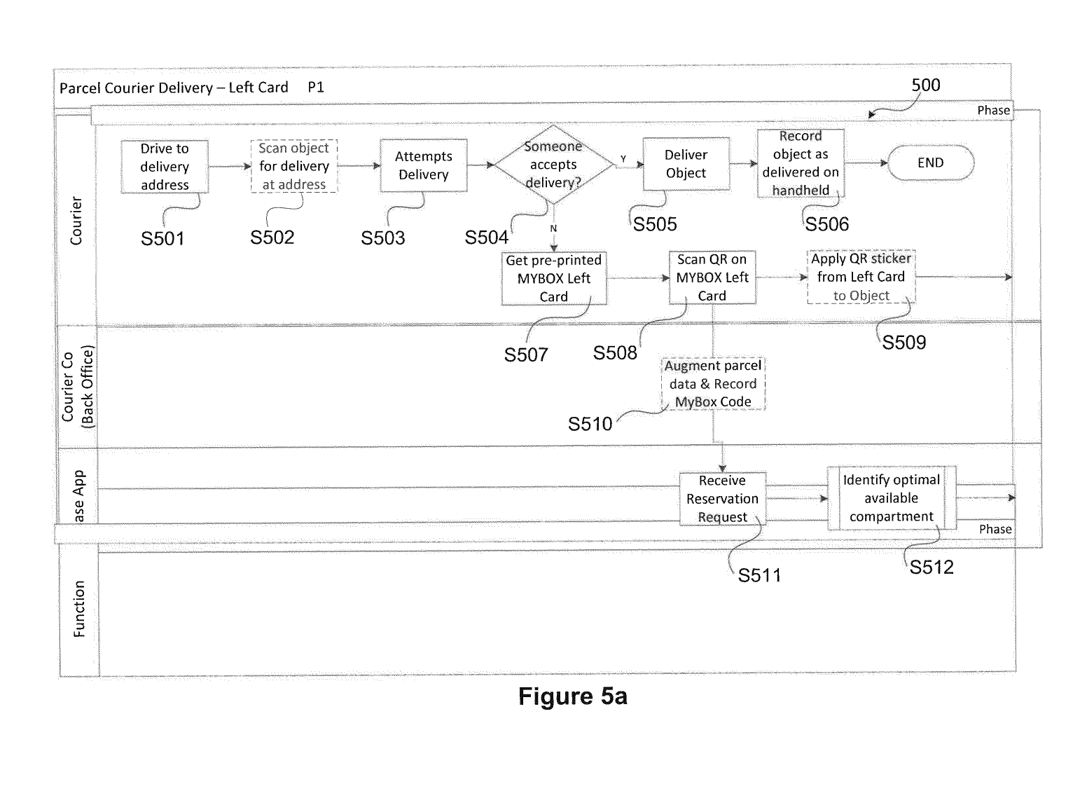

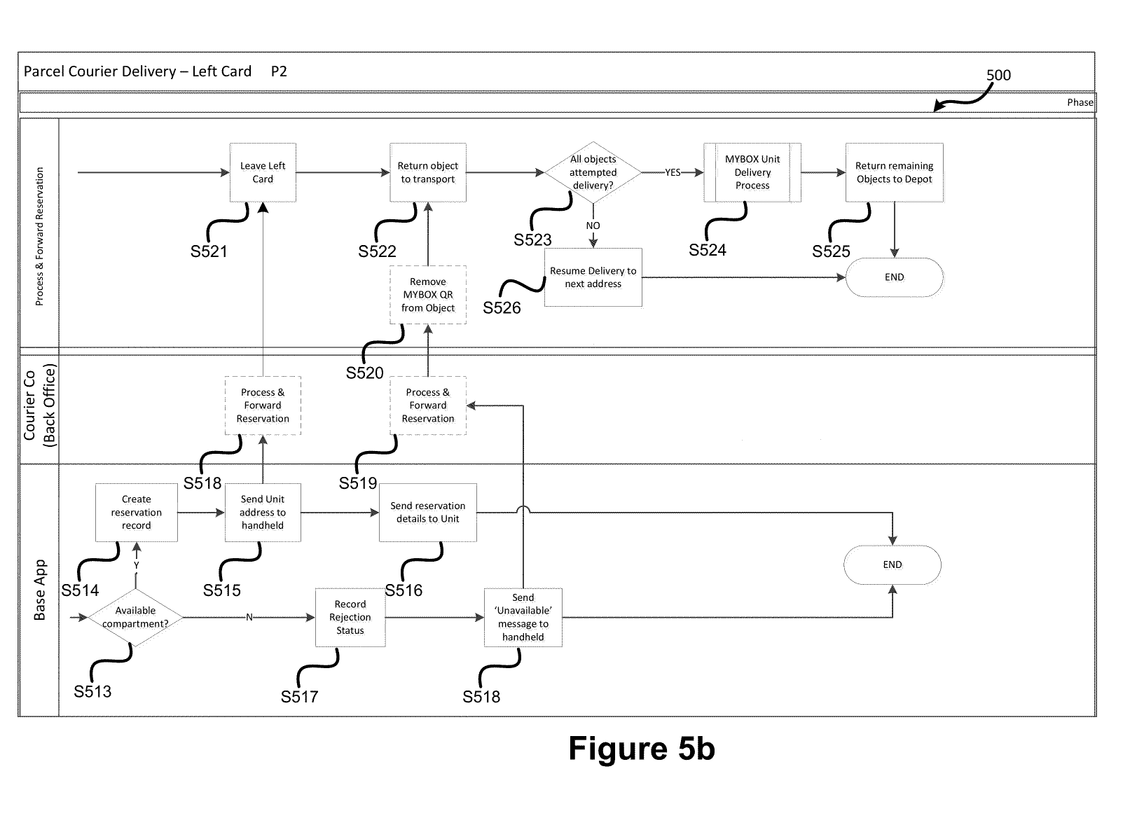

FIGS. 5a and 5b are flow diagrams showing a method 500 for leaving a MyBox left card 105 in the event that a recipient is not home to receive delivery of the object. The method 500 begins at step 501 where the courier 102, for example drives to the delivery address of the recipient and may optionally scan the object for delivery at the address using their mobile communication device 103. This step 502 is optional in the sense that the courier 102 may scan the object for tracking purposes which are related to delivery or left card purposes. Control then moves to step 503 where the courier 102 attempts delivery of the object to the recipient. Control then moves to step 504 where it is determined whether or not there is an appropriate recipient at the address to accept delivery. In the event that the recipient is at home, control moves to step 505 where the object is delivered. Control then moves to step 506 where the courier 102 records the object as delivered via a device such as a mobile communication device 103.

If at step 504 there was no one to accept delivery of the object, control moves to step 507 where a pre-printed MyBox left card 105 is obtained and control moves to step 508 where the unique identifier contained on the MyBox left card 105 is scanned by the courier 102 using a mobile communication device 103. At step 509 the courier may optionally apply a sticker containing the unique identifier from the MyBox left card 105 to the object and then control moves to step 521 where the MyBox left card 105 is deposited in the recipient's postal box, door, or similar location, for example (although will be appreciated that this may be in a form of an electronic communication, if required). Optionally, if the reservation is rejected by MyBox base application 108, the courier 102 may leave the courier's standard left card and the courier may write the parcel's tracking number on the left card by hand. If the reservation is rejected and the courier leaves a MyBox left card 105, MyBox base application 108 will inform the recipient that they must contact the courier to arrange delivery. This may occur in a number of ways including via a record in the database that the object was not stored and the recipient may be informed upon login to the MyBox website or by the recipient calling MyBox customer service for example. MyBox base application 108 may also take the opportunity to sign up the recipient to the membership service, and will then arrange the object's delivery per that process (not shown).

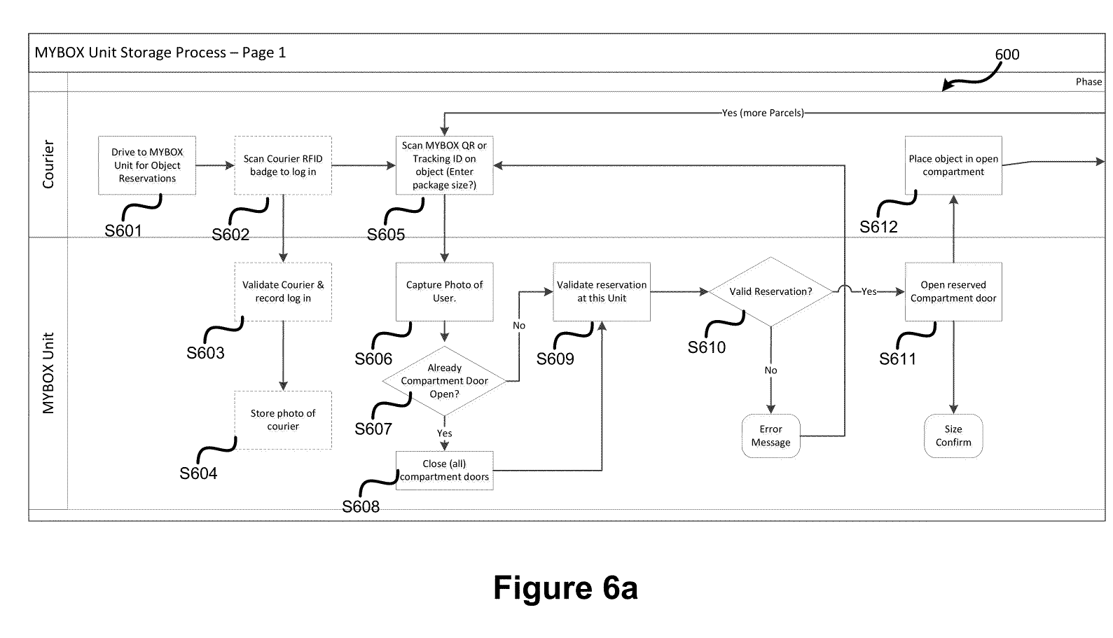

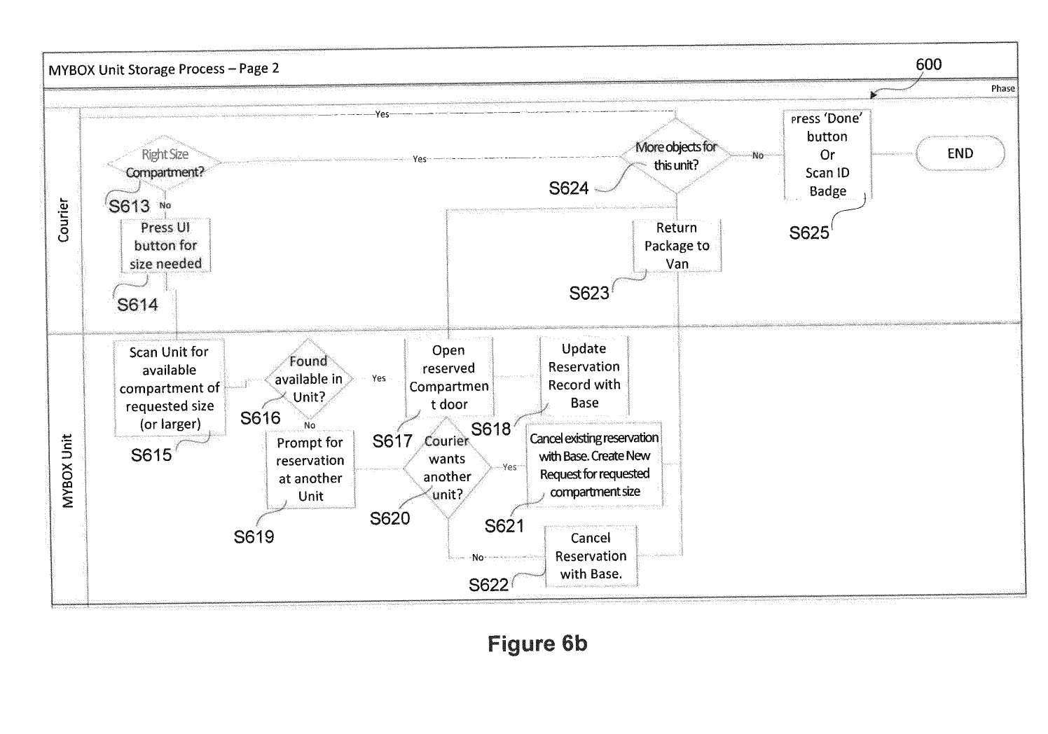

The courier may or may not remove the QR sticker from the object for rejected reservations (in the event the object has a sticker). If the courier leaves a MyBox left card 105, then the sticker should remain in case the recipient decides to sign up for MyBox's membership service and MyBox arranges redelivery. Alternatively, the MyBox website associated with the MyBox base application 108 or MyBox customer service may be able to provide tracking information from the courier and direct the customer to the courier to arrange pickup. Control then moves to step 522 where the courier returns the object to the courier transport 101. Control then moves to step 523 where it is determined whether all objects have been attempted to be delivered. In the event that they have not, control moves to step 526 and the courier 102 resumes delivery to the next address, otherwise control moves to step 524 where the second location delivery process is carried out as will be described further with reference to FIGS. 6a and 6b and control moves to step 525 where the remaining objects are returned to the depot. As described earlier, at step 508 the courier 102 scans the unique identifier on the MyBox left card 105 via his mobile communications device 103. This initiates the reservation request transaction from the mobile communications device 103 to MyBox base application 108. From step 508 control may pass to step 510 which is optional where the reservation request transaction may pass via the courier company 106 where it will augment data to the transaction and forward it on to MyBox base application 108 via the Internet 115. Couriers may optionally need to manually enter object details via their mobile communications device 103 to complete the reservation request. Control then moves to step 511 where at the MyBox base application 108 the reservation request is received. Control then moves to step 512 where the MyBox base application 108 determines the optimal available second location and compartment. It will be appreciated that the second location may be determined by recipient preferences (provided the recipient is set up as a member) or other algorithms as described with reference to FIG. 1.

Control then moves to step 513 where it is determined whether or not there is an available compartment available at a second location identified at step 512. In the event that there are no suitable compartments available, control moves to step 517 where the MyBox base application 108 records a rejection status and control moves to step 518 where an unavailable message is sent to either the courier 102 via their mobile communication device 103 or as optionally shown in step 519 to the courier company 106 which processes and forwards this information to the courier 102 via their mobile communication device 103. Control then moves to step 520 where the courier may be instructed to remove the MyBox unique identifier from the object and return the object to the courier transport 101 at step 522. In the event no MyBox unique identifier was applied to the object then no action is required. Otherwise at step 513 if there is an available compartment, control moves to step 514 where a reservation record is created and stored at the MyBox base application 108. Control moves to step 515 where the address of the second location is provided to the courier 102 via mobile communication device 103. Optionally, this information may also be forwarded at step 519 to the courier company 106 and then to the courier 102. Control moves to step 516 where reservation details are sent to the second location and this process ends (but it will be appreciated that the other branch of the method may loop) before the object is delivered to the second location which will be described further with reference to FIG. 6.

FIGS. 6a and 6b are flow diagrams showing a method 600 for storing objects. The method starts at step 601 where the courier 102 drives the courier transport 101 to the second location in the form of MyBox storage unit 110 for delivery of the objects. Control then moves to step 602 where the courier may log into the storage unit 110 via, for example an RFID card. It will be appreciated that this step could be replaced by any number of authentication methods, such as Near Field Communication Device (NFC) or QR badge or in combination with a password or biometric identification, such as fingerprint ID. Alternatively, simply scanning the object's unique identifier such as a barcode could be enough to authenticate for this process if there is a matching reservation. At step 603 the courier 102 is validated and logged as entering the MyBox storage unit 110. Optionally, at step 604 a photo of the courier 102 may be stored accessing the MyBox storage unit 110. Control moves to step 605 where the unique identifier on the object is entered. At this point the courier 102 may enter the dimensions of the object which may necessitate a move to a different compartment within the MyBox storage unit 110 or these may have been provided earlier. For example, when posting the item this information may have already been collected by the courier company 106 and included in the reservation request as augmented data and therefore may dictate the size of the compartment to use, or it may have been manually entered by the courier 102 at the time of making the reservation request. As part of selecting an optimal storage compartment and storage unit 110 the MyBox base application 108 may use dimensional information in the reservation request to determine the minimum size compartment to accommodate the object. If no dimensional data is included with an object's reservation request, then a reverse-cubing algorithm may be used to estimate the dimensions based on the object's weight. If the recipient is known to MyBox (and able to be confirmed—e.g. name & address) then the MyBox base application 108 may employ algorithms to select the ‘most preferable’ unit and compartment location based on one or more parameters as described with reference to FIG. 1. For example, this may be based on a number of parameters (e.g. close to recipient's address, recipient's favourite petrol station or grocery store, preferences for compartments not above a particular height for wheelchair-bound or short recipients). Alternatively, if the preferences of the courier company take precedence over the recipient's, then the MyBox base application 108 may select the ‘most preferable’ unit/compartment based on the courier's preferences. This will likely be the closest unit—or one along the courier's route. Couriers 102 may also want to ‘cluster’ object storage activities to minimize stops on the route as described with reference to FIG. 3. Control then moves to step 606 where a photo is captured of the user who has entered the unique identifier. At step 607 the MyBox storage unit determines whether or not the compartment door is open (i.e. a compartment door from storage of the previous object in the event multiple objects are being stored). In the event that the door is open, control moves to step 608 where the doors for the compartment are closed and latched and control moves to step 609 where validation against the unique identifier is made. If at step 607 the door was not open control moves directly to step 609. Step 609 will authenticate the QR code by confirming the unique identifier and its associated hash and will then attempt to look up in the local database the reservation associated with the unique identifier. At step 610 it is determined whether or not the unique identifier is valid and the reservation is for this storage unit 110, and, in the event that they are not, an exception is processed at step 611 and a message is provided to the user and control returns to step 605. Otherwise, control moves to step 612 where the reserved compartment door is opened. Step 611 may take several actions (not shown in FIG. 6a, but described here) to process the exception condition where either the QR code is not valid or the reservation is not for the current storage unit 110, and this step may offer the user the option to transfer a reservation from another storage unit 110 to the current storage unit 110. If the QR code is unreadable, step 611 may prompt the user to manually enter the reservation unique identifier and or a hash manually via the unit controls (described further with reference to FIG. 7a). If no input is received or the hash does not authenticate the unique identifier or the unique identifier does not meet minimum validation criteria, then a control system (described further with reference to FIG. 7a) delivers an appropriate message to the user and control then moves to 605.

In the event that the QR is deemed valid and or authenticated from step 610 but the unique identifier does not have a matching reservation in the local database for the current storage unit 110, then the unit control system 700 will query the MyBox base application 108 to determine if there is a valid reservation matching the unique identifier at another storage unit 110. If the MyBox base application's 108 reply indicates that there is no currently valid reservation for that unique identifier anywhere in the MyBox network or it is not transferable, then the control system may deliver an appropriate message to the user and control then moves to 605. If the reply from the MyBox base application 108 indicates that there is a valid reservation for that unique identifier at another storage unit 110 and that the reservation can be transferred, then the control system may query the local database to see if an appropriate compartment is available in the current storage unit 110 for the object. If an appropriate compartment is not available in the current storage unit 110, then the unit control system may deliver an appropriate message to the user and control then moves to 605. If the unit control system determines that an appropriate compartment is available in the current storage unit 110, then the control system will query the user if they would like to transfer the existing reservation to the current storage unit 110. If the user indicates that they would like to transfer the reservation to the current storage unit, the control system may send a reservation transfer message to the MyBox base application 108, update the local database, and control transfers to step 612. If the user indicates that they would like to keep the existing reservation at the original storage unit 110, then the unit control system 700 may deliver an appropriate message to the user and control then moves to 605.

In an alternative, this step may also check if no reservation exists and there is no suitable compartment available at the present storage unit, but a valid compartment is available at another storage unit, notifying the courier 102 of the reserved location of the other unit for the object, providing the courier 102, the option of switching the object to this storage unit if there is a suitable unreserved compartment and, where appropriate, if it is consistent with the recipient's preferences. Further this step may also check with the MyBox base application 108 if there is no reservation at any storage unit on the network and provide the courier the option of switching the object's reservation to a particular storage unit if there is a suitable unreserved compartment; and may optionally provide a direct voice connection to a customer service agent while at the storage unit.

The courier 102 may confirm the size of the compartment. This will provide the courier 102 the option to change compartment sizes if the object does not fit in the reserved compartment. A size change request may be logged as an event for later analysis. If the courier 102 requests a larger compartment and there is not one available at this storage unit 110, the program code (805) will query the MyBox base application 108 for an appropriate compartment nearby or consistent with the courier company's 106 or member's preferences. Preferably, the system operates on the assumption that if the recipient is a member of MyBox and did not indicate that on the shipping information, then they do not necessarily want their preferences used or their membership referenced. In this case, the courier company's 106 preferences are used to find an ‘optimal’ unit location as previously described with reference to FIG. 1. For example, there may be a distance threshold limit (e.g. 5 km) for the second location—so that when a search is conducted for available compartments, second locations those beyond this threshold may be ignored. In the event that there are no suitable compartments available within the threshold, then the reservation may be rejected and the object returned to the courier's depot. It will be appreciated that the threshold distance could be variable—e.g. 5 km in the city, and 15 km in the country, as well as variable by courier.

If the courier 102 requests a smaller compartment and there is not one available at the storage unit 110, the unit application will inform the courier 102 that a smaller compartment is not available and they should use the one allocated.

Control then moves to step 613 where the courier 102 places the object in the open compartment and at step 614 is determined whether or not the compartment is the right size. For example, does the object fit inside the compartment—i.e. “is the compartment too small?”, or would the object fit in a smaller compartment—i.e. “is the compartment too big?” The objective is to store the object in the smallest compartment in which it will fit. In the event that the compartment is not the right size, control moves to step 615 where a user control is activated requesting that the MyBox storage unit 110 provide a different size compartment. Control then moves to step 616 where the program code 805 scans the unit's local database (not shown) to determine if a compartment of the requested size or larger is available within the unit. Control then moves to step 617 where it is determined whether or not an available compartment of that size is available in the MyBox unit 110. In the event it is not, control moves to step 620 where the courier 102 is prompted if they'd like a reservation at a different storage unit 110 (i.e. at a different location). Control then moves to step 621 where it is determined whether or not the courier 102 wants a different storage unit 110. In the event that they do not, control moves to step 623 where the reservation is cancelled and this exception is handled by updating on the MyBox base application 108 and in turn the courier company 106, and at step 624 the courier 102 may return the object to the courier transport 101. At step 625 it is determined whether or not there are more objects to be provided in this MyBox storage unit 110. If there are, control returns to step 605, otherwise control moves to step 626 where the courier 102 activates a ‘done’ user control to indicate that the storage process is complete.

In the event at step 621 that the courier 102 wants a different storage unit, control moves to step 622 where the existing reservation is cancelled with the MyBox base application 108 and in turn the courier company 106, and a new request is made for the new compartment size at the different location. Control moves to step 624 where the package is returned to the courier transport 101. At step 625 more objects may also be stored, otherwise control moves to step 626 when the user control for ‘done’ is activated and the courier leaves the MyBox storage unit 110.

In the event that the different sized compartment is available, at step 617 control moves to step 618 where the compartment door is opened and control moves to step 619 where the reservation record is updated with the MyBox base application 108 and in turn the courier company 106. If at step 614 the compartment was the right size, control moves to step 625 where it is determined whether there are more objects to be placed in this MyBox storage unit 110. If there are, control returns to step 605, otherwise control moves to step 626.

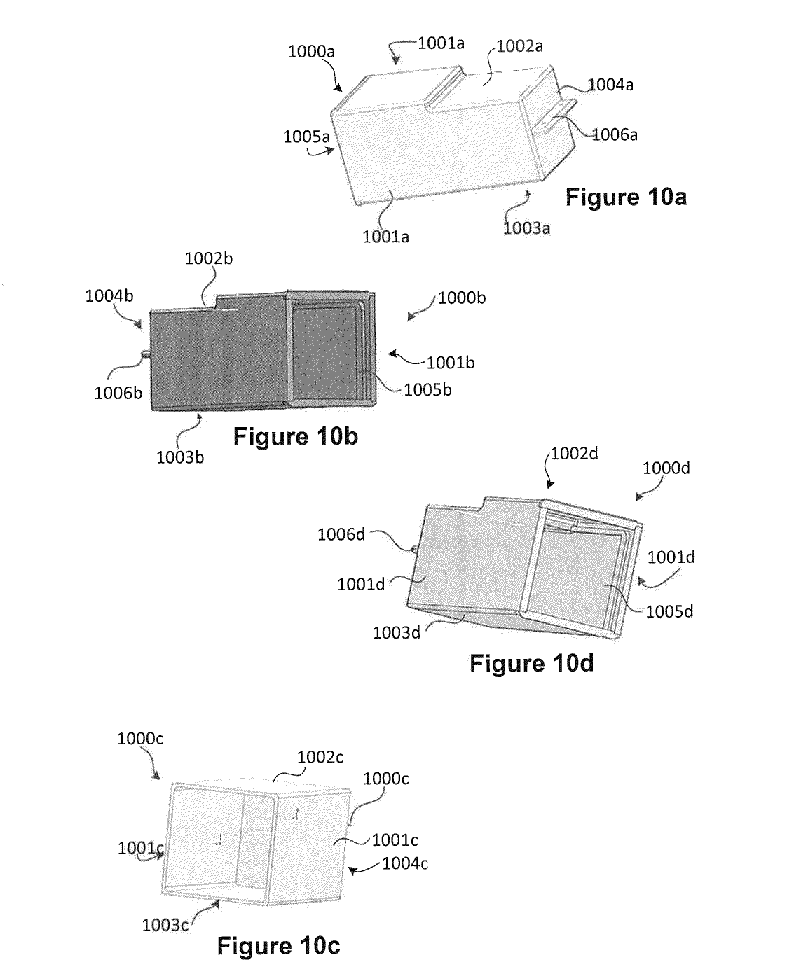

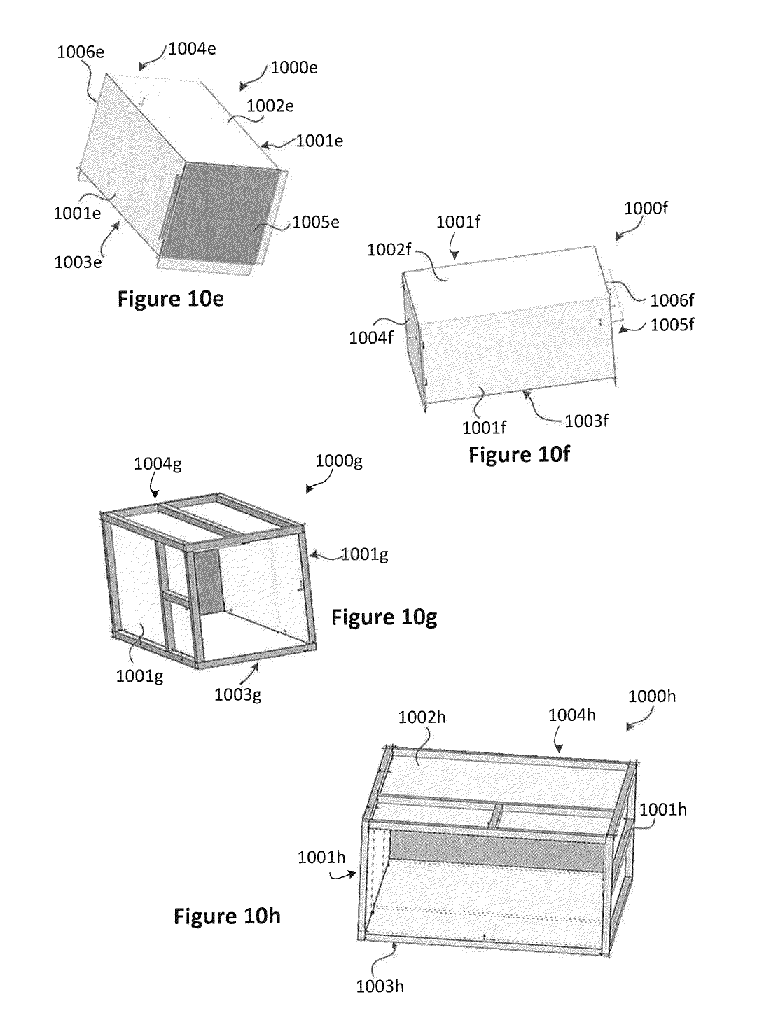

FIG. 7a is a diagram of a MyBox storage unit 110 which provides a housing for one or more compartments 705 for storing objects and includes a control system 700 to control operation of the MyBox storage unit 110 and access to the compartments 705. The MyBox storage unit 110 is a standalone unit that allows automatic management of the storage compartments 705 contained within the unit 110 for receiving and dispensing objects. It will be appreciated that the MyBox storage unit 110 is secure and advantageously is reconfigurable and transportable and extendable. The MyBox storage unit 110 as a minimum includes a base panel 701, side panels 702, a rear panel 703 and a ceiling panel 704. A front panel 712 may also be included. It is possible that in a particular installation one or more panels 701-704 and 712 of the storage unit may be replaced by a secure surface such as a floor or ceiling or wall, etc. Contained within the MyBox storage unit 110 are one or more compartments 705. In FIG. 7a, there is shown compartments 705a-705j being one size and compartments 706a-706d of a different size. It will be appreciated that compartments of other sizes may be utilized in the MyBox storage unit 110 as will be described further with reference to FIGS. 9 and 10.

Each MyBox storage unit 110 includes a unit control system 700 to control access to the compartments and the objects stored within them. The control system 700 maintains a local database of reservations and holdings and communicates with the MyBox base application 108 which maintains a master list of all reservations and activities. A user display 708 and user interface 709 is provided so that couriers and/or recipients can interact with the control system 700 to store or retrieve an object. It will be appreciated that the user display 708 and user interface 709 may also be combined, for example using a computer touch-screen panel. A microphone and speaker (shown in FIG. 8) may be included to provide one or two-way audio communication with a user. A camera 707 may also be used to support user identification and a card reader 710 may also be included in addition to user interface 709. A scanner 711 may be included in the set of controls to read a variety of barcodes. A printer 713 may be included to provide hardcopy output to the user, for example reservation details or payment receipt or a barcode corresponding to a reservation or the like.

Compartments 705a-705j and 706a-706e as shown in FIG. 7a are example modular compartments that fit within the MyBox storage unit 110 and electronically connect to the control system 700. They may vary in size to accommodate different sized or shaped objects. Advantageously, the compartments may be removable and replaceable for reconfiguration. For example, as can be seen in FIG. 7, compartment 705a, 705b, 706a and 706c may be arranged to provide two small compartments and two large compartments. Further, compartment 705c, 705d, 705e, 705f and 706c may be arranged to provide four small compartments and one large compartment and so on. The compartments will be further described with reference to FIG. 9.

It will be appreciated that the outer portion of the MyBox storage unit 110 may be a secure box like structure similar to a vending machine or refrigerator or may be larger in size and stored permanently in a building, for example. Preferably, the MyBox storage unit 110 is constructed of steel or similar robust material to provide security and tamper resistance and to secure the compartments 705. The front face of the MyBox storage unit 110 may be made up of the one or more front faces of the compartments 705a-705j and 706a-706e and front faces of each of these compartments include a door or face panel to secure and enclose the object in the compartment 705. The front face may also include a fascia panel 714 in FIG. 7b.

The side panels 702, base panel 701, rear panel 703 and/or ceiling panel 704 of the MyBox storage unit 110 may be connected to a wall or floor through welding or the use of fasteners, such as bolts to prevent theft of the MyBox storage unit 110.

It will be appreciated that the fascia 714 bounded by edges of the side panels 702, base panel 701 and ceiling panel 704 may be hinged on one side or secured through locking bolts on multiple sides and lockable by an authorised person. A fascia 714 as shown in FIG. 7b may be placed over the edges of the compartments 705/706 and may be fastened to the perimeter of the side panels 702, base panel 701 and rear panel 703 to secure the edges of the compartments 705 in place in addition to internal fastening [not shown].

It will be appreciated that the MyBox storage unit 110 may take a variety of shapes and sizes and need not be limited to a particular shape, such as a rectangle or similar dimensions. For example, a lateral rectangular shape or square shape could also be used as required. It is possible that in a particular installation one or more panels of the storage unit 701-704 may be replaced by a secure surface such as a floor or ceiling or wall, etc.

The MyBox storage unit 110 may itself be modular in that one or more additional MyBox storage units 110 may be placed alongside the MyBox storage unit 110 and interconnected.

It will be appreciated that while FIG. 7a depicts the control system 700 on the front face 712 of the cabinet of the storage unit 110, these could be placed on the fascia 714 of FIG. 7b, or a side panel 702 of the cabinet or in an entirely separate kiosk [not shown] as best fits the particular storage unit's 110 shape and the installation.

FIG. 8 is a schematic diagram showing the control system 700 as shown in FIG. 7a. The control system 700 includes a processor 801 which is connected to a sensor panel 802 which includes one or more sensors to electrically monitor the cabinet for movement, position, shock, smoke detection etc. The processor 801 is also connected to a data transfer device 803 which may include a modem or Wifi transceiver and a GPS receiver for communication with the MyBox base application 108 and for transactions and data synchronization. The sensor panel 802 may also have a direct connection to the data transfer device 803 for direct security communications or the sensor panel 802 may incorporate its own separate modem. The processor 801 also runs a program code 805 in memory to execute the necessary processes and to operate the various components. The processor 801 is also associated with data storage including a database (not shown) to store, index and access the necessary data. Also connected to the processor 801 is a compartment control block 804 (which interfaces with the compartment control system to control actuators and other components associated with the one or more compartments 705 and which will be further described with reference to FIG. 12).

The processor 801 also controls a barcode scanner 806 for scanning the unique identifiers associated with an object, for example. RFID/NFC (Radio Frequency Identifier/Near Field Communications) reader component 808 is also controlled by the processor 801, the RFID/NFC reader 808 for reading of RFID cards and tags as well as NFC-enabled credit cards and mobile phones allowing authentication of users 811 and the processing of credit cards. A camera 807 is also provided to identify and/or record users of the MyBox storage unit 110. A rechargeable battery 809 may also be provided (in addition to AC power—not shown). An electric solar panel or similar power generation component (not shown) may also be included to provide an independent power supply. A touch screen 810 is provided to display information and controls and for interaction with a user 811 to operate the MyBox storage unit 110. A microphone and or a speaker (neither shown) may be incorporated to provide pre-recorded audio instructions, accept voice input from a user 811, or to provide one or two-way communications with a user 811. One or more biometric sensors may be integrated (not shown) such as fingerprint sensor, retina scanners, palm print scanner, devices that measure heat patterns, devices that measure or map capillary structures, or similar biometric devices that measure particular characteristics or aspects of the human body.

The control system 700 may also incorporate a card reader 812 connected to the embedded computer 801 to read credit cards, identification cards, magnetic strip cards, embedded chip cards, and the like. Advantageously, this enables the control system 700 to confirm a user's identity or to process a payment on a credit or bank card, or other type of card holding/representing monetary value.

The control system 700 may also include a printer 813 connected to the embedded computer 801 to print text, pictures or barcodes (1 D and 2D) for presentation to the user. The printer is ubiquitous in that it may print out any text or image in black and white or colour.

Advantageously, the inclusion of the NFC/RFID reader 808, magnetic card reader 812, and the printer 813 enables the storage unit 110 to support additional processes such as ‘collection on delivery’ (COD) or processing payments for various processes including for unattended drop off of parcels for courier pickup and shipping, or issuance of receipts and dockets, or barcoded dockets representing reservations for later access to compartments.

One or more mass sensors 815 may be attached to measure the weight of all the compartments and provide this input to the processor 801. By comparing the measurement of the weight of the compartments before a storage action and after a storage action the processor can confirm that an object has been stored or removed.

The data transfer device 803 may be a WiFi transceiver and may provide a unique way to interact with the user 811 who has a personal smart phone (not shown) as an alternative to the touch screen 810. The WiFi transmitter can provide an unsecured, standard WiFi (802.11 et. al.) beacon signal. Users 811 of nearby WiFi-enabled devices, such as a smartphone, tablet or any device with a common HTML browser can elect to connect to the WiFi signal similar to how one would to a public internet café. However, this WiFi signal would connect the user 811 to a web service which is part of the program code 805 and not to the Internet. In this way the storage unit presents the user with a graphical, web-like user interface, video, sound and other media to instruct and to interact with the user to reserve, store, or retrieve items from the storage unit.

FIG. 9 illustrates a number of compartments 900-905 which may be provided in the MyBox storage unit 110 of FIG. 7a. As will be appreciated, a variety of shapes and different sized compartments 900-905 may fit within the MyBox storage unit 110. They may be stacked or interconnected with each other or using an interior framework within the MyBox storage unit 110 itself, or may stack on top of and alongside one another. Advantageously, the modularity of the compartments together with their ease of replacement provides the MyBox storage unit 110 to be reconfigured at will. For example, compartment 900 has dimensions X wide and Y high. So as to be modular, compartments 901 and 902 are sized ½ X wide and ½ Y high, compartment 903 is ½ X wide and Y high, and compartments 904, 905 are X wide and ½ Y high.

FIGS. 10a-10h show various alternative compartment 705 designs which may be incorporated into the MyBox storage unit 110. Each of the compartments 1000a-1000h include opposing side compartment panels 1001a-1001h, base panel 1003a-h, ceiling panel 1002a-h, rear panel 1004a-h interconnecting the side walls and ceiling wall and base wall and a front face 1005a-h which acts as a door including an actuator which enables the door to be opened or closed and a latch which enables the doors to be locked or unlocked. Operation of the actuator and latches will be further described with reference to FIG. 12. As will be appreciated, a hinge mechanism may be provided to open or close the door. The compartment itself as shown in FIG. 1000a-h is a five sided box structure which is preferably constructed from durable material such as polyethylene (HDPE, LLDPE, HHDPE and the like) or of a type of metal, such as aluminium or steel. Like the MyBox storage unit 110, the internal compartments 1000a-h can be fabricated in either a frame and skin arrangement or a set of connected panels, i.e., compartment 1000a and 1000b sharing a wall 1001a, for example. Each of the panels 1001a, 1003a, 1004a, 1002a may be securely interconnected to each other through welding or mechanical fastening. Alternatively, polyethylene type compartments may be constructed by injection moulding or rotational moulding. Preferably, each compartment has a connector component 1006a-h which allows the compartment 1000a-h to be secured to the interior of the MyBox storage unit 110. This is so that the compartment cannot be removed from the MyBox storage unit 110. The front face of each compartment 1005a-h preferably includes an attached door that securely closes the compartment and is lockable. The door may be hinged to the compartment or its frame or may be arranged in another method such as an interior fitted tambour door, which prevents unauthorised access. The compartments 1000a-h may be further secured by a fascia 714 (shown in FIG. 7b) of the cabinet which marries to the outer edges of each of the compartments 1000a-1000h (or compartments 705a-j and 706a-d as the example depictions in FIGS. 7a and 7b) and prevents the removal of the compartment while the fascia 714 is secured in place to the storage unit cabinet 110.

Preferably, each compartment includes an actuator in the form of hardware to securely lock and unlock the door 1001a-h to the interior of the compartment. One or more actuators control the opening and closing of the door of the compartment via the control system 700. Each compartment will also be associated with a compartment control system which will be further described with reference to FIG. 12.

Advantageously, the compartments 1000a-h which are placed inside the MyBox storage unit 110 are modular, such that their width and height dimensions have common factors, i.e., being a multiple of a base distance. Preferably, all compartments 1000a-h adhere to a maximum depth which is determined by the internal depth of the housing of the MyBox storage unit 110. For example, if the largest compartment that will fit into the cabinet is X millimetres wide and Y millimetres high then a number of smaller compartments can be fabricated to fit within the same space.

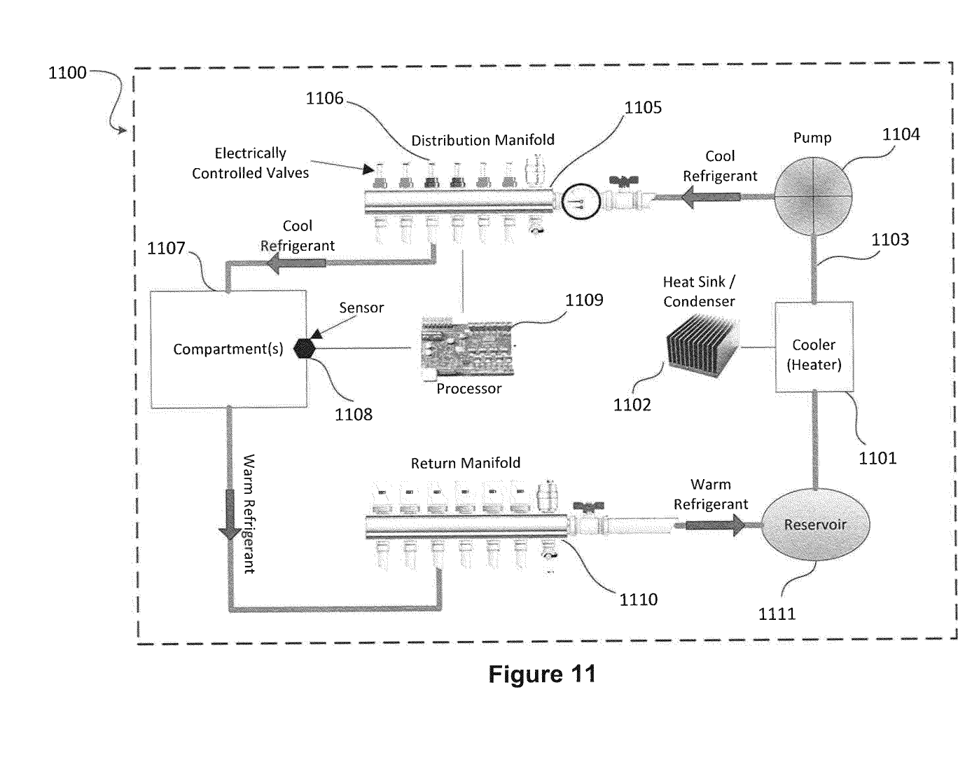

FIG. 11 is a schematic diagram of an environmental control system 1100 for independently controlling the environment within each storage compartment 705. The environmental control system 1100 may be optionally fitted to storage units 110 and interfaced to the processor 801 to provide climate control for storage of objects which require specific temperatures and or humidity levels. This will enable the storage of objects which may require greater environment control such as fresh foods, frozen items, wines, tobacco products (e.g. fine cigars), pharmaceuticals and the like.

The environmental control system 1100 includes a heat pump/cooler component 1101 and a condenser/heat sink 1102 (which may be a commercially available refrigeration unit or heat pump for example, a common cyclic refrigeration cooler heat pump consisting of a compressor, evaporator and a condenser). It will be appreciated that an alternative heat pump 1101 may be used such as a thermoelectric cooler (TEC), for example a Peltier-heat pump, a magnetic heat pump or a sonic cooler or similar solid state heat pump. For example, TECs may be applied directly to the storage compartments or could act as ‘chillers’ for a refrigerant used as a heat transport medium. TECs also offer the advantage of greatly reducing maintenance and can be reversed to act as heaters and dehumidifiers. TECS may also utilize the heat sink 1102 to dissipate excess heat.

It will be appreciated that depending on the requirements, other heat pumps/coolers 1101 may be used—alone or in combination or in stages—to produce the necessary compartment temperatures. Other commercially available cooling components may be used alone or in combination for the heat pump 1101

Where required the transport of cooling power to the point of need may be achieved by using a liquid or gas or multistate refrigerant (not shown) inside of tubing 1103. The tubing 1103 may be a variety of types, shapes and materials to suit the purpose of efficient heat transfer or insulated for the prevention of heat transfer as best suits the need at the particular point in this system. The refrigerant will flow within these tubes 1103 through natural convection and or through propulsion from an electric pump 1104. The refrigerant may then flow through the tubing 1103 to a distribution manifold 1105 for distribution to the individual storage compartments 1107. Flow to a particular compartment or stoppage of flow can be controlled through a control valve 1106 which will open to divert the refrigerant to a specific compartment 1107 and will close to stop the flow.

The refrigerant absorbs heat energy from the compartment 1107 by circulating through and/or around the compartment 1107 which effectively cools the storage compartment 1107. Refrigerant circulation may occur through tubes 1103 placed adjacent to or through the compartment panels 1001-1005 as shown in FIG. 10. Heat transfer to the refrigerant may be facilitated by using metal tubes fastened to the compartment panels (not shown), or through using components such as aluminium panels (not shown) designed specifically to facilitate heat transfer.

Compartments 1107 for environmentally controlled storage units 110 will vary from standard compartments 705 with the addition of cooling and/or heat transfer elements (as described above), the addition of layer(s) of insulation (not shown) and the attachment of electronic sensors 1108 which monitor the temperature and humidity of the compartment. The electronic sensors 1108 are connected to an electronic processor 1109. The electronic processor 1109 monitors the temperature and humidity of the compartment 1107 as reported by the sensors 1108 and compares it to an assigned temperature required for the stored object as determined in the reservation request. The processor 1109 may open or close the electronic valve 1106 on the distribution manifold 1105 to provide or stop additional refrigerant flowing to the compartment 1107 to achieve the target temperature. The electronic processor 1109 is also connected to the overall storage unit control system's processor 801 to receive instructions and to receive target temperatures and humidity settings for each compartment and to provide status information to the control systems' processor 801. The environmental control system's processor 801 also provides this information as part of its status updates to the MyBox base application 108.

The algorithms and rules that control the opening and closing of the refrigerant valves may be controlled by the compartment processor 1109 or by the unit control system processor 801 or a by a combination of these. Inputs and outputs may also be provided to and from a compartment control system header board (which will be further described with reference to FIG. 12. Similarly, either or both processors 801 and 1109 may control the mode, operation and degree of heat transfer produced by the heat pumps/coolers 1101 and or the refrigerant pump 1104.

The warmed refrigerant leaves the circulation around the compartment 1107 via the tubes 1103 and is consolidated from multiple compartments via a return manifold 1110. The refrigerant flows through the tubes 1103 from natural convection and/or pressure induced from an electric pump 1104. Excess refrigerant is stored in one or more reservoirs 1111 until needed. It will be appreciated that the reservoirs may be placed in various points within the system. The warmed refrigerant is then re-cooled by the heat pump/cooler 1101 and the cycle repeats as needed. Additional coolers 1101 can be added to the reservoirs 1111 to further cool the refrigerant as may be required.

An alternative arrangement may use Peltier or TECs or similar solid state or electronic coolers (not shown) attached directly to the compartment 1107 which are electronically controlled by the processor 1109. These can provide cooling or heating (alone or in combination) to the specific compartment 1107 in order to achieve the target environment.

Heat sinks or condensers 1102 may be placed within the storage unit 110 or external to the storage unit 110 to facilitate the release of heat energy from the environmental control system via convection or assisted by one or more fans (not shown).

An alternative arrangement may use a staged cooling system may be used where the first subsystem (e.g. TECs) cools the compartment 1107 directly and a second subsystem (e.g. cyclical compressor) is used to cool the heat sink from the first subsystem. Another alternative arrangement may use a combination system where the first subsystem (e.g. cyclical compressor) cools the entire interior of the cabinet including the compartments 1107 and a second subsystem (e.g. TECs) cools or heats the compartment 1107 directly to achieve the target environment.

In the combination arrangement, the excess heat from the first subsystem (e.g. from the heat sink or condenser 1102 from the first subsystem) may be used to directly heat the compartment 1107 to achieve the target environment. Advantageously, this removes the need for an additional heating or cooling component 1101 in the second subsystem.

In both these alternative arrangements the subsystems that directly heat or cool the compartments 1107 are electronically controlled by the processor 1109 and or 801; for example, when a compartment may need to be warmer than the interior temperature. Heating of compartments 1107 may also be performed as needed by reversing the heat transfer of the heat pump 1101 or by reversing the heat transfer of additional TECs in a combination or multistage configuration.

The ability of the invention to provide cooled storage at prescribed temperatures will provides an advantage for the shipment and delivery of groceries, such as fresh produce, dairy, meat ice cream, frozen meals, and similar products requiring cool storage temperatures and specific humidity levels.

A further advantage is provided to farmers and agricultural cooperative organisation to sell and deliver farm-fresh produce in small order batches to customers who do not need to be home to receive the deliveries. By providing environmentally controlled storage for farm produce, MyBox component 107 will create a new sales and delivery channel for such groups. This will provide the recipient with fresher produce than is generally available at supermarkets or green grocers. This will further provide the farmer or sellers with far greater profit margin be eliminating several steps in the usual supply chain on a mass scale.

FIG. 12 is a schematic diagram of a compartment control system 1200 for independently controlling access to each storage compartment 705. Each storage compartment 705 will have a compartment control system 1200, which includes one or more of the following components.

Components such as a camera 1202, a mass sensor 1203, interior lighting 1204, visual indicator 1205, audio indicator 1206, door actuator 1207, door sensor 1208, latch actuator 1209 and latch sensor 1210 are electronically connected to a “Header Board” 1201 which is an electronic device associated with each compartment that is directly connected to the control system 700 (described with reference for FIG. 7a) which monitors and directly controls the connected components of the compartment control system. This connection may be via the compartment control block 804. This arrangement may provide secondary function, such as unique addressing and bus monitoring of the control system 700. Alternatively, the header board 1201 may include low-level processing and programming that will execute simple processes within the compartment control system based on events, parameters and inputs within the compartment control system. These events, parameters and inputs may be provided by the unit control system 700.

A camera or visual sensor 1202 can be included in the compartment control system 1200 and positioned to monitor the interior of the compartment 705. Advantageously, the camera provides still or moving images of the compartment 705 interior, which will enable a visual inspection of the interior for cleaning and maintenance, inspection and visual record of a particular object stored in the compartment, a confirmation if the compartment is empty or occupied, a visual recording of users storing or removing objects from the compartment 705, or the like.

The mass (weight) sensor 1203 detects changes in the mass of the entire compartment or of objects placed inside. The mass sensor 1203 passes information to the processor 801 via the header board 1201, which can enable detection of objects within the compartment and the measurement of the mass (weight) of the object within the compartment. This information can be used to support unattended shipping and drop off of objects or to detect discrepancies between the mass of stored objects and previously recorded mass values of the object as provided by the couriers 102 courier companies 106 or others.

The Interior lighting 1204 is controlled via the header board 1201 to facilitate a users' storage or removal of objects as well as the recording of images (photos or video) in the interior and may be used in combination with the camera 1202. Interior lighting 1204 can be provided from any commercially available lighting elements, such as light emitting diodes (LEDs), or similar light sources. The header board 1201, or processor 801, controls the activation and deactivation of the lighting to correspond with the opening or closing of the compartment 705, or the activation of the camera/visual sensor 1202.

The visual indicator 1205 is used to alert the user to the particular compartment 705 that has been activated for their use. The visual indicator 1205 may include a lighting element, such as light emitting diodes (LEDs), or similar light sources, or another device that illuminates or displays a contrasting area visible to the user which identifies the compartment 705 apart from others. This can be used to visually indicate to a user which compartment 705 is to be used to store or remove an object for the process being executed.

Audio indicator 1206 alerts the user 811 to the particular compartment 705 that has been activated for their use. The audio indicator 1206 may include a speaker, buzzer, or similar device that produces an audible sound to the user 811 which identifies the compartment 705 apart from others. This can be used to aurally indicate to a user 811 which compartment 705 is to be used to store or remove an object for the process being executed and may be used in combination with the visual indicator 1205.

The visual indicator 1205 and the audio indicator 1206 may be particularly useful for disabled user 811, such as hearing-impaired or sight-impaired users 811, respectively.

The door actuator 1207 opens and closes the compartment 705 door to support execution of the relevant process (such as that described with reference to FIGS. 6a and 6b). This door actuator 1207 may take the form of a screw actuator, a motor, an electromagnetic device or similar. A corresponding door sensor 1208 is provided to detect the status of the compartment 705 door—i.e. if it is open, closed, or in any other state.

An electrically controlled latch actuator 1209 is provided to secure and release the compartment door. The latch actuator 1209 may take the form of a screw actuator, a motor, an electromagnetic device or similar. A corresponding latch sensor 1210 is provided to detect the status of the compartment 705 door—i.e. if it is latched, unlatched, or in any other state.

It will be appreciated that components 1202-1210 of the compartment control system 1200 may be connected to the processor 801 directly or via the compartment control block 804.

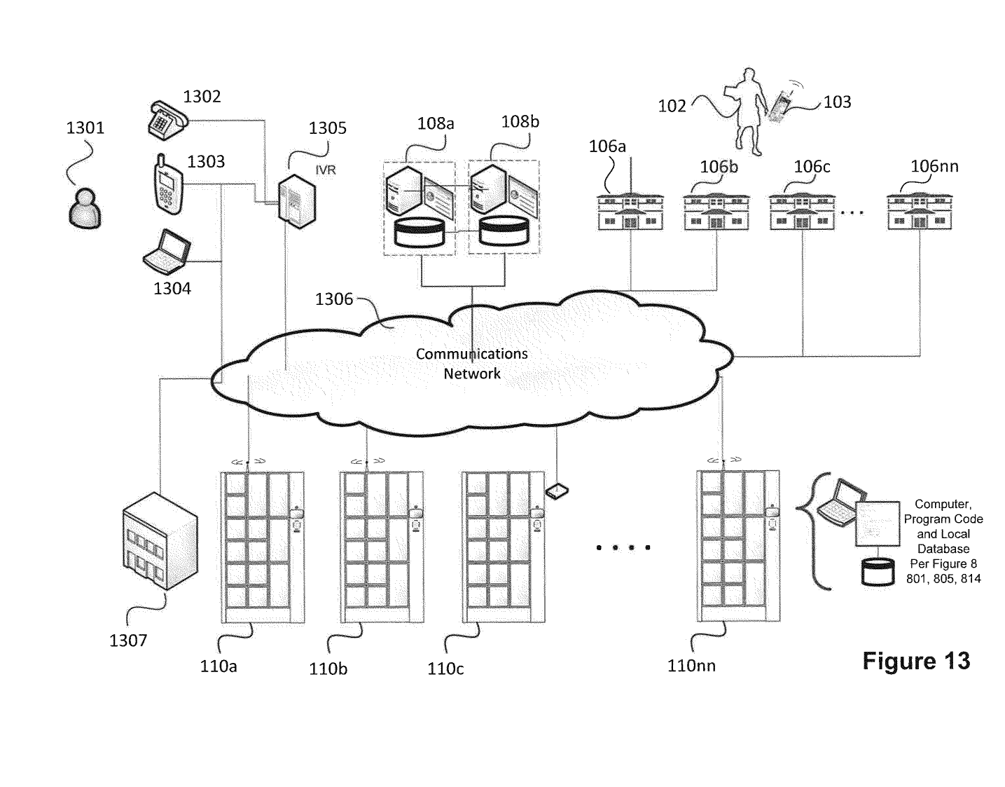

FIG. 13 is a diagram showing the network aspect of the invention. The network aspect of the invention provides it with unique capabilities. Advantageously, the system and method of the present invention allows for a very high degree of scalability, availability and resilience through its design. The MyBox base application 108 is connected to the network of storage units 110a-110nn via a communications network 1306. The system may include multiple instances of the MyBox base application 108. This is depicted in FIG. 13 as instance 108a and instance 108b. There may be one, two or any number of these instances. The instances of the MyBox base application 108 may be configured in a primary and backup or failover mode, or these instances could be configured to share management and processing load, or could be further configured to carry a sub-division of the processing, such as for a particular geographic location.

The network 1306 can be the Internet, a private network, a virtual private network, a public network, a cellular telephone and data network, a PSTN network or the like. It can also use these various networks alone or in combination, which provides a number of alternate means of communication. Both the MyBox base application 108 and the storage unit program code 805 are designed to utilise several modes of the network 1306 of communication in case one or more are unavailable. In particular, storage unit 110c, for example, is depicted without a wireless network connection and instead using hard wired modem network connection, or the like.

As described above with reference to FIG. 8, each storage unit has within it a processor/computer 801, a set of program code 805 and a local database 814.

Because the MyBox base application 108 sends and receives data to each storage unit 110a-110nn based on its particular reservations, these storage units have the capability to operate even if completely disconnected from the network 1306.

Further, the local database 814 and program code 805 within the storage units 110a-110nn enables them to receive and process ‘walk-up’ reservation requests from users for their unit's compartments. Advantageously, the system and method of the present invention is designed such that the storage unit 110a-110nn and its program code 805 are able to continue operating for a period of time even if disconnected from the network 1306.

If the MyBox base application instances 108a-108b are disconnected from the network 1306, but one or more storage units 110a-110nn remain connected to the network 1306, they are able to interact with each other directly. In this mode a ‘walk-up’ reservation request will first be filled at the immediate location as described above. If there are no available compartments at the immediate location, the program code 805 can directly poll nearby storage units 110b-110nn to determine if a nearby storage location has available compartments and to lodge the reservation at the selected storage unit.

Note that when the system operates with one or more components unable to communicate with the rest, the degree of utilisation is expected to decrease.

If all base application instances 108a-110nn were to catastrophically lose their data, then the system is designed such that the base application can re-create an accurate and up-to-date ‘picture’ of the status of the entire network by polling each storage unit 110a-110nn and uploading the data stored in its local database 814. Advantageously, this level of distributed redundancy ensures a very high degree of availability to a very high degree of confidence.

The MyBox base application 108 preferably includes a ‘store and forward’ capability to ensure that if a storage unit 110 is disconnected temporarily from the network 1306, the reservation message will be held and re-attempted until received and acknowledged by the storage unit application 805 and stored in its local database 814 (i.e once network connection 1306 is re-established). The storage unit application 805 has similar ‘store and forward’ capability to ensure that if a storage unit 110 is disconnected temporarily from the network 1306, the storage and pickup messages for a given compartment and reservation will be held and re-attempted until received and acknowledged by the MyBox base application 108.

Advantageously, each storage unit application 805 may include a ‘heartbeat’ function to send asynchronous status messages at pre-determined times to the MyBox base application 108. The MyBox base application 108 will in turn send an acknowledgement of receiving the ‘heartbeat’ message, which may include a status indicator. The MyBox base application 108 will know the periodicity of the heartbeat and will monitor them. In this way not only will the MyBox base application 108 have real-time status of the entire network, it will be able to identify faults in the network in very short order based on a negative status or a missed heartbeat, and can issue appropriate alerts.

As part of the communication protocol (messaging) between the MyBox base application 108 and the storage unit application 805, the MyBox base application will be able to ‘push’ operational instructions to the storage unit. One form of this message may be updates to configuration parameters used by the storage unit application 805. For example, as the network expands, the MyBox base application may ‘push’ the interval between heartbeats from 10 minutes to 20 minutes to cope with the increase in heartbeat processing. Or, if a particular storage unit has a history of communication issues, it may change the interval for a particular storage unit to 5 minutes. Another form of this message may ‘push’ and updated set of code for the storage unit to use as a replacement application 805—much like how many smartphone applications have the ability to automatically check for new versions to automatically download and install the newer version.

As depicted in FIG. 13, the system also includes connection of multiple courier companies 106a-106nn to the network 1306. This enables the courier companies 106a-106nn to request reservations and to send and receive other types of operational messages. FIG. 13 further shows certain location providers 1307 who may elect to also interact with the system. If so connected, the location providers 1307 may perform additional functions and processes, such as identity verifications of recipients, couriers and senders, collection of fees or payments, if any, and a variety of other services. These may be provided by MyBox application or integrated through existing point-of-sales systems the location providers 1307 may have.

Advantageously, the recipient 1301 does not need to sign up or even be aware of the system prior to using it. Agreements with courier companies 106 enabe them to use the system. A left card 105 (either physical or virtual) may be the first interaction the recipient has with the system. This provides enormous flexibility to our courier partners as they do not need to know if any particular recipient has subscribed to the service in advance.

Couriers can place a reservation request and instantly know where they can store the particular item. There is no need to maintain a waitlist of reservation requests or for the courier to return to the delivery site (once or repeatedly) to attempt deliveries as with other approaches. The courier requests a reservation and the invention will find them an available storage compartment at a viable second location. In the event that there are none available at that time, the invention can give the courier a future reservation. In this way the courier does not need to return to the delivery site, but can store the item (and multiple items) at a single storage unit.

In a further advantage, the present invention removes or at least mitigates the costly risk of failed delivery attempts from the courier company. The system and method of the present invention provides suitable secure storage at a second location in the event the recipient is not in attendance at the primary delivery location. This way the courier will pay for the service only if they choose to use it and can eliminate the costs of time, effort, and fuel of returning to the primary delivery location for further redelivery attempts.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1. A computer implemented method for delivery of one or more objects including the steps of:
determining one or more parameters related to the object;
determining if the object can be delivered to a first location; and
in the event that the object cannot be delivered to the first location:
generating a unique identifier,
associating the unique identifier with the object;
initiating a reservation request to deliver the object to a second location;
automatically determining a second location based on one or more parameters; and
providing notification of successful reservation request and second location.

2. The method of claim 1, further including the steps of determining an optimal compartment within the second location based on one or more parameters.

3. The method of claim 2, wherein the parameters include one or more of the size of the object, the type of object, courier preferences, recipient preferences or size and availability of a compartment.

4. The method of claim 1, including the step of determining an optimal second location based on one or more parameters.

5. The method of claim 4, wherein the parameters include one or more of: the second location being within a threshold distance from a recipient address, type of object to be delivered, one or more predetermined delivery preferences; based on other objects to be delivered at the same time; or number of objects in a multi-object consignment.

6. The method of claim 4, wherein the optimal second location is determined based on the availability of multiple compartments at the second location.

7. The method of claim 1, wherein the method further includes the step of providing the unique identifier to the recipient.

8. The method of claim 1, wherein the method further includes the step of extracting predetermined object data for each object.

9. The method of claim 8, wherein the predetermined object data includes size, weight, fragility, type of object, service class and/or environmental requirements.

10. The method of claim 1, wherein initiating a reservation request for a second location includes scanning the object's unique identifier via a mobile communication device.

11. A computer implemented method for storage of one or more objects including the steps of:
generating a unique identifier,
associating the unique identifier with the object;
scanning the unique identifier associated with the object at a second location, the second location including one or more compartments for storage of objects, and the second location including one or more reservations associated with the one or more compartments;
matching the unique identifier with the reservation;
unlocking an appropriate reserved compartment in the second location for the one or more objects;
closing the compartment after a predetermined time or detection of object inside the compartment;
locking the compartment once the compartment is in a closed state;
providing inventory data relating to compartment; and
notifying the recipient that the object has been stored in the second location.

12. The method of claim 11, wherein the compartment is locked once a predetermined time period has expired since the compartment was closed.

13. The method of claim 9, wherein inventory data includes providing a timestamp each time the compartment is opened and closed.

14. A modular storage system, including:
a housing having a base panel, two opposing side panels and a rear panel between the two opposing side panels;
one or more removable modular compartments provided within the housing;
each compartment including:
two opposing side compartment panels, a base panel, a rear panel and a front panel; the front panel including a locking component,
wherein the one or more compartments further include an actuator for locking and unlocking the front panel and an actuator for opening and closing the front panel of each of the one or more compartments; and a control system for controlling the actuators.

15. The system of claim 14, wherein the one or more removable modular compartments include an anchoring component for attachment to the housing.

16. The system of claim 14, wherein the anchoring component is formed on an outer face of one of the compartment panels.

17. The system of claim 14, wherein the one or more compartments includes a common maximum depth Z, and one or more compartments has width and height that are a fraction of the interior dimensions of the housing such that for a combination of compartments within the storage unit, the sum of the widths of the compartments and the sum of the heights of the compartments is equal to width and height of the interior dimensions of the housing.

18. The system of claim 14, wherein the one or more compartments includes a common depth Z, one or more compartments has width X and height Y, and wherein one or more compartments includes a width and height that is a fraction of the width X and height Y such that, for a combination of compartments within the storage unit, the sum of the widths of the compartments and the sum of the heights of the compartments is equal to width and height of the interior dimensions of the housing.

19. The system of claim 14, wherein the one or more compartments includes a common depth Z, one or more compartments has width X and height Y, one or more compartments has width ½ X and height ½ Y, one or more compartments has width ½ X and height Y and one or more compartments have width X and height ½ Y.

20. The system of claim 14, wherein the housing may include a frame to position each of the one or more compartments in the housing.

21. The system of claim 14, wherein the one or more compartments share one or more of a common a wall panel, side panel, base panel or ceiling panel between adjacent compartments.

22. The system of claim 14, further including an environmental control system adapted to control the temperature of the one or more compartments.
